(19) United States
(12) Patent Application Publication
(10) Pub. No.: US 2004/0151815 A1
(43) Pub. Date: Aug. 5, 2004

(54) Edible flavor improver, process for its production and use

(75) Inventors: John Preben Jensen, Nakskov (DK); Hakan Gros, Kantvik (FI); Ole Hansen, Nakskov (DK); Anu Ennelin, Espoo (FI); Margaret Elisabeth Ellison, Northants (GB); Joern Marcussen, Viby J. (DK)

Correspondence Address: SCULLY SCOTT MURPHY & PRESSER, PC, 400 GARDEN CITY PLAZA, GARDEN CITY, NY, 11530

(73) Assignee: Danisco Sugar Oy, Kantvik (FI)

(21) Appl. No.: 10/702,686

(22) Filed: Nov. 6, 2003

Related U.S. Application Data
(60) Provisional application No. 60/424,255, filed on Nov. 6, 2002.

(51) Int. Cl. A23L 1/22

(52) U.S. Cl. 426/534

(57) ABSTRACT

The invention relates to a product based on a sugar beet extract, which is useful as a flavor improver in ingestible products, particularly in foodstuffs, especially in beverages sweetened with other than natural sugar. The invention also relates to a process for preparing said product starting from various streams of the beet sugar manufacturing process. The process of the invention is based on membrane techniques and/or chromatographic fractionation. The invention also relates to the use of said product as a flavor improver in ingestible products. Furthermore, ingestible products including said product are covered by the invention. The invention also relates to a method of improving the flavor of ingestible products by adding said product to the ingestible product.

### CROSS REFERENCE TO RELATED APPLICATION

The present application claims benefit of U.S. provisional application Serial No. 60/424,255 filed Nov. 6, 2002.

### FIELD OF THE INVENTION

The present invention relates to the field of sugar manufacturing industry and flavoring industry. It is especially directed to an edible flavor improver comprising an essentially non-volatile mixture containing non-sucrose components of sugar beet extract. The mixture is used for enhancing the organoleptic characteristics of ingestible products, especially of sweetened food products. The invention also relates to processes for the production of the flavor improver and to ingestible products containing the same

The flavor improver of the invention is processed from various beet sugar process streams, such as raw juice, thick juice and molasses. The products of the invention are useful in the flavoring industry to improve the taste of sweetened and non-sweetened foods and pharmaceuticals. They are especially useful in bringing the flavor of ingestible products sweetened with non-sucrose sweeteners or with a reduced amount of sucrose closer to that of corresponding products sweetened with sucrose. The products of the invention are capable of improving the flavor of various ingestible products, particularly foodstuffs and especially beverages, which are sweetened with sweeteners other than sucrose.

The processes of the invention relate to the manufacture of the flavor improver starting from liquids derived from various stages of the beet sugar manufacturing process. The products are used as flavor improvers in ingestible products, particularly foodstuffs and especially beverages, to enhance the sugar-like flavor.

### BACKGROUND OF THE INVENTION

Sugar (sucrose) is still today the most commonly used sweetener and the taste of sugar is what people all over the world expect from a sweet product. Sugar imparts sweetness to the product but in addition to that, it provides a mouthfeel and an aftertaste which is pleasant and which does not seem to depend on the saccharose alone. It is well known that extracts of sugar beet and sugar cane contain besides saccharose a huge number of compounds which all have their own taste and some of which influence the organoleptic properties of the sugar. Some of these compounds are included in the raw extract, others are produced during the processing. Attempts have been made to analyze the components affecting the taste and texture of sugar, but the complexity of the system is so great that no clear picture of the active components has been obtained.

Sugar has a high caloric value and a cariogenic impact on the teeth. This is partly why so many non-sucrose sweeteners have been developed. Such artificial sweeteners with reduced calorie value are used to a large extent as sugar replacements in food technology, especially in diet and low-calorie foods and beverages. These artificial sweeteners are either essentially calorie-free, which are often referred to as low-calorie or intense sweeteners, or they have a significantly reduced calorie content.

Examples of low-calorie sweeteners which are used in beverages and other ingestible products are saccharin, aspartame, potassium acesulfame, sucralose, neotame (not used in beverages), alitame, and cyclamate. Other new sweeteners are being developed, for example tagatose and trehalose.

The low-calorie sweeteners, however, lack the bulk needed for many products in which they are used. Polyols are often used in combination with the low-calorie sweeteners to provide bulk and improve texture and mouthfeel. Examples of polyols used for sweetening purposes are xylitol, sorbitol, lactitol, maltitol, mannitol, erythritol and hydrogenated starch hydrolysates including maltitol syrups, sorbitol syrups and hydrogenated glucose syrups.

Fructose is also used as a sweetener to replace sucrose obtained from sugar beet or sugar cane. Enzymatically converted corn starch provides high-fructose syrups (HFCS), which have revolutionized the sweetener industry in many countries and provided an important alternative to sucrose both in regular and reduced-calorie food products. The main area of use of high-fructose corn syrup is the manufacture of beverages. Other application uses are processed foods, baking products, ice cream and confectionary products, for example.

The flavor of high-fructose corn syrup is not quite identical with that of natural sugar, i.e. sucrose derived from sugar beet or sugar cane. It seems that some components providing the desired sugar-like flavor are not present in products sweetened with high-fructose corn syrup. Furthermore, high-fructose corn syrup include a number of non-desired off-flavors, which typically originate for instance from the manufacturing processes. From the point of view of the consumer, modification of the flavor of high-fructose corn syrup, when added to food products, so as to be closer to the flavor of natural sugar would thus be highly desirable.

In the same way as the high-fructose corn-syrup, many non-sucrose sweeteners and especially artificial sweeteners have the disadvantage that their flavor when added to food products is different from that of sugar. Modification of the flavor of these sweeteners closer to that of sugar would thus be desirable.

Beverage manufacturers have been using blends instead of single sweeteners in reduced-calorie beverages, as blends can act synergistically to improve the properties of beverage products. By creating new blends of sweeteners or modifying the proportions of sweeteners in current blends, manufacturers can optimize the sweetening compositions for specific types and flavors of beverages.

S. Meyer and W. E. Riha (“Optimizing Sweetener Blends for Low-calorie Beverages”, Food Fechnology, vol. 56 (2002), no 7, pp. 42 to 45) disclose that the sweetness, mouthfeel and stability of low calorie cola, fruit and lemon-lime beverages can be optimized by modifying the blends of high-intensity sweeteners. For cola beverages, five high-intensity sweeteners (acesulfame K, aspartame, sodium saccharin, cyclamate and sucralose), alone and in various combinations were tested. Different combinations of flavorings were also tested for fruit-flavored beverages (with orange, peach and strawberry flavor). Furthermore, blends of acesulfame K with aspartame and sucralose in carbonated lemon-lime drinks were evaluated. Sucrose was used as the reference in the tests. The results of the studies showed that there are significant benefits to be gained from customizing sweetener blends when developing new beverages or reformulating existing beverages. The role of the sweetener has progressed beyond that of a “calorie-reducing agent” to an ingredient which can add real value in influencing and optimizing taste and stability as well as economics.

EP 0 132 444 B1 (General Foods Corporation) discloses a process for modifying the sweetness of foodstuffs, for example those sweetened with aspartame, by adding m-hydroxybenzoic acid and/or food-acceptable non-toxic salts thereof to said foodstuff. The reference also discloses food-stuffs compositions, premix foodstuffs and sweetening compositions including said compound.

WO 99/15032 (Holland Sweetener Company V.O.F) discloses the use of 2,4-dihydroxybenzoic acid or a physiologically acceptable salt thereof as as a sweetness modifier in foodstuffs sweetened with aspartame.

U.S. Pat. No. 6,287,620 B1 (Firmenich S A) discloses a method of improving, enhancing or modifying the taste properties of a flavoring composition or food products, for instance light products having a low fat or sugar content, by using specific α-keto acids, ingestible salts thereof, or mixtures thereof with corresponding amino acids. Said flavoring compositions or food products typically include artificial sweeteners as the main sweetener component. It is recited the α-keto acids provide a more natural character to the products in which they are used.

U.S. Pat. No. 5,474,791 (The NutraSweet Company) discloses the use of a tamarind extract as a replacement for the phosphoric, citric and other acids conventionally found in carbonated soft drinks, flavored waters and ice tea products, which are sweetened with aspartame. The resulting beverage has a higher pH, thus increasing the shelf life of beverages containing aspartame, as well as a flavor profile equivalent to or better than that of conventional beverages sweetened with aspartame.

U.S. Pat. No. 5,633,031 (The Nutrasweet Company) discloses improved carbonated soft drinks and other beverages sweetened with aspartame and colored by caramel color. The beverages contain positively charged caramel color as a substitute for 5 to 70% of the conventional caramel color used in beverages, which is negatively charged. The resulting products have improved taste characteristics.

U.S. Pat. No. 6,372,277 B1 (Holland Sweetener Company V.O.F.) discloses soft drinks, concentrates and syrups sweetened with a dipeptide sweetener and containing a fructosyl saccharide. The sweetening power of these products is maintained for a longer time during storage if the fructosyl saccharide therein is a fructan with fructosyl units linked mainly via β-2,1 bond, a chain length of 3 to 100 units, with the modal and the mean chain length each being at least 4.75, and with the pH of the products being 2.5 to 4. Said fructosyl saccharides occur naturally as storage carbohydrates in a wide variety of plants, e.g. belonging to the families Compositae, Liliaceae and Cerealeae, or they are products derived from such natural products by a chemical or enzymatic modification, e.g. hydrolysis. Fructosyl saccharides can also be obtained chemically or enzymatically from fructose and/or sucrose.

U.S. Pat. No. 4,228,198 (Tate & Lyle Inc.) discloses the use of arabinogalactan as a sweetness modifier in sweetening compositions containing protein sweeteners and/or saccharin. Arabinogalactan, also known as larch gum, is a naturally occurring polysaccharide obtained from larch trees. It is recited that the use of arabinogalactan provides enhanced sweetening properties, the sweetness profile is more rounded and unpleasant after-tastes are minimized.

U.S. Pat. No. 6,379,735 B1 (Takasago International Corporation) discloses a method of the preparation of a sugar-like flavorous component based on the volatile components of molasses. The product is recited to impart a mellow feeling and a natural flavor to beverages and flavorous compositions. The method comprises adding ion exchange water and ethanol to molasses, mixing and dissolving the components and distilling the resulting solution in a spinning cone column to be treated therein in the following conditions: the temperature of 40 to 60 ° C., strip rate of 0.5 to 7% and the degree of pressure reduction of 70 to 100 kPa. Molasses used as the raw material is obtained as a by-product from sugar manufacture.

Natural distillates from various fruits, vegetables and crop sources such as sugar cane to provide sugar sweetness are also known in the art (Innovation in Food Technology 2001 (September), (12), 76). The distillates are prepared by a range of specific techniques, including a short duration/low temperature distillation process, maximizing flavor entrapment. It is recited that with these natural distillates, the smooth sweet character of honey or cane sugar can be provided to diet drinks, dairy desserts, smoothies, milk drinks and confectionary products.

One example of the above-mentioned distillates is a flavor distallate collected entirely from sugar cane, which is recited to impart a fresh, natural sugary taste to food systems without adding calories, sugar, protein or color (Confectionary-Production 2001 (February), 67 (2), 27). The sugar cane distillate has been manufactured by specific techniques to concentrate the volatiles of sugar, maximizing flavor entrapment, while leaving behind the sucrose. The sugar cane distillate is particularly suitable for use in diet and low-calorie products, where it works synergistically with artificial sweeteners. It masks their metallic, dry taste and gives a more natural flavor to the product as well as improves the overall mouthfeel.

U.S. Pat. No. 6,245,376 B1 (International Flavours and Fragrances Inc.) discloses a process for producing one or more tastands including one or more natural food additives-based on distillates of sugar cane, comprising the sequential steps of (a) providing a plurality of sugar cane leaves, macerates thereof or a mixture of sugar cane leaves and macerates thereof, and (b) carrying out one or more physical separation unit operations on said leaves, macerates or a mixture thereof to obtain a natural tastand based on sugar cane material. The physical separation unit operations include for instance steam distallation, high pressure extraction, for example with screw presses, pervaporation, extraction using an extraction column such as a charcoal extraction column, standard fractionation distillation, batch or continuous, high pressure volatile solvent extraction, and super critical carbon dioxide extraction. The tastands thus obtained are especially useful in foodstuffs, chewing gums and beverages, which are sweetened with sweeteners other than natural sugar or which contain sodium chloride replacers.

The above-mentioned U.S. Pat. No. 6,245,376 B1 also discloses a process for removing the bitter aftertaste and enhancing the sweetness of a cola beverage sweetened with aspartame by adding to said beverage a compound named damascenone and an alcohol compound selected from cis-3-hexenol, 1-octen-3-ol and β-phenylethyl alcohol, or by adding β-homocyclocitral and an oxo compound selected from cis-3-hexenol and acetophenone, or by adding a mixture of cis-3-hexenol and a pineapple compound.

Membrane techniques and chromatography are both well known in the field of sugar manufacture to separate sucrose from sugar juices in the sugar manufacturing processes using sugar beet or sugar cane as the raw material.

U.S. Pat. No. 6,444,022 B1 (Tate & Lyle Inc.) discloses a sugar beet membrane filtration process for producing sucrose from sugar beet pulp. The membrane filtration can be done with an ultrafiltration membrane or a nanofiltration membrane, for example. In one embodiment of said process, the membrane filtration is carried out using two successive ultrafiltration steps optionally combined with diafiltration, followed by a nanofiltration step, thereby producing a nanofiltration permeate and a nanofiltration retentate. The nanofiltration retentate contains most of the sucrose from beets. In a preferred embodiment of the process, the nanofiltration retentate contains at least about 89 to 91% by weight of sucrose (on dry substance basis). The nanofiltration permeate, on the other hand, is recited to contain at least about 25 to 50% of the betaine present in the nanofiltration feed. Loose nanofiltration membranes with NaCl rejection of about 10% are recited to be well suited for the nanofiltration step.

The above-mentioned reference U.S. Pat. No. 6,444,022 B1 also proposes chromatographic separation for further purification of the sucrose-containing retentate obtained from the ultrafiltration/diafiltration. A purified sucrose fraction is thus obtained. The reference does not propose separating other product fractions.

U.S. Pat. No. 6,406,546 (Tate & Lyle Industries) discloses a process for obtaining sucrose from a sucrose-containing syrup, which is typically a low grade sugar syrup, juice or liquor, such as molasses containing also a significant concentration of invert sugars. The process comprises nanofiltration of a feed syrup that contains sucrose and invert sugars to obtain a nanofiltration permeate and a nanofiltration retentate. The nanofiltration permeate comprises invert sugars and the nanofiltration retentate has a concentration of sucrose higher than in the feed syrup and a concentration of invert sugars lower than in the feed syrup. The nanofiltration retentate comprising the sucrose is recovered. The feed syrup may be selected for example from beet molasses, beet juice, beet thick juice, beet thin juice, and mixtures thereof. The nanofiltration membrane has a typical cut-off size of 100 to 500 daltons. Before the nanofiltration, the syrup may be filtered through a microfiltration or ultrafiltration membrane to obtain a microfiltration or ultrafiltration permeate, which is then subjected to nanofiltration. The microfiltration or ultrafiltration retentate may be subjected to diafiltration to obtain a diafiltration permeate, which may be combined with the microfiltration or ultrafiltration permeate prior to nanofiltration. Other product fractions are not recovered in the process.

U.S. Pat. No. 5,466,294 (The Amalgamated Sugar Company) discloses a process for purifying raw juice obtained from sugar beets, comprising subjecting the raw juice to a softening procedure to remove calcium, concentrating said soft raw juice to produce a soft raw syrup, subjecting said soft raw syrup to a chromatographic separation procedure to obtain a purified raw syrup extract containing less than about a half of the non-sucrose dissolved solid constituents contained by said raw juice. The chromatographic separation is typically carried out using a low cross-linked gel type chromatographic separation resin in a monovalent metal form. The raw syrup extract obtained is then subjected to sugar recovery by crystallization.

G. Vaccari et al. describe cooling crystallization applied to the extract of a chromatographic separation process (SMB) of beet raw juice in Zuckerindustrie 126 (2001), no. 8, pp. 619-624. In this process, beet raw juice is microfiltered without the traditional calco-carbonic purification step, softened and put through a chromatographic separation process using a SMB (simulated moving bed) pilot plant. The fraction rich in sugar, “extract”, is then crystallized by subsequent cooling crystallization steps with the purpose of obtaining commercial white sugar.

EP 0 957 178 A2 (Eridania S.p.A.) discloses a method for the preparation of white sugar of commercial quality from raw beet sugar, including (a) microfiltration or ultrafiltration of the beet juice, after separating the organic and mineral particles whose size is above 50 μm, by means of membranes with a pore size between 5000 MWCO and 0.5 μm, (b) juice sweetening, (c) juice concentration in multiple effect evaporators, (d) cooling crystallization of the juice thus obtained, and (e) separation and washing of the crystals.

U.S. Pat. No. 5,902,409 (Societe Nouvelle de Recherches et d'Applications Indutrielles d'Exhangeurs d'Ions Applexion) discloses a process for the manufacture of crystallized sugar from an aqueous sugar juice containing sugars, organic impurities including colloids, and mineral impurities, comprising (a) filtering said sugar juice via tangential microfiltration, tangential ultrafiltration, or tangential nanofiltration for removing a substantial part of said colloids, to produce a retentate and a permeate, (b) concentrating the permeate to give a syrup, and (c) crystallizing said syrup to give crystalline sugar and molasses. The crystallization may be followed by a chromatographic fractionation of the molasses product to give a sugar-depleted liquid effluent and a sugar-enriched liquid effluent. The sugar-depleted liquid is not recovered as a product.

Chromatographic methods for the recovery of a betaine product from beet molasses are known in the art. One such process is described in U.S. Pat. No. 4,359,430 (Suomen Sokeri Oy). In this process, the chromatographic separation for the recovery of betaine is carried out with a polystyrene sulphonate cation exchange resin, typically in an alkali metal form. Another chromatographic process using a simulated moving bed system for the recovery of betaine from molasses is disclosed in U.S. Pat. No. 5,127,957 (Heikkilä et al.). The columns of the chromatographic system are typically filled with a strong acid cation exchanger resin in a monovalent metal form, preferably in sodium and/or potassium form. Further chromatographic processes for the recovery of betaine from beet-derived solutions, such as molasses, are disclosed in U.S. Pat. No. 6,093,326 (Danisco Finland Oy) and WO 96/10650 (Cultor Oy).

### DEFINITIONS RELATING TO THE INVENTION

The following definitions and abbreviations are used in the specification, examples and claims in connection with the present invention, unless otherwise indicated:

“A liquid withdrawn from a beet sugar manufacturing process” and “a sugar beet extract” refer to a stream or fraction withdrawn from any stage of the beet sugar manufacturing process. Examples of the liquids withdrawn from a beet sugar manufacturing process are raw juice, thick juice or molasses. Said liquid may also be an intermediary fraction taken from the sugar crystallization process, for example.

“Raw juice” refers to the sugar juice obtained from the sugar extraction step, where sliced sugar beet is subjected to extraction to extract the sugar from beets (before the sugar juice purification step).

“Thick juice” refers to the evaporated thin juice obtained from the raw juice after the purification step (the juice before the sugar crystallization).

“Molasses” refers to the residual liquor from the sugar crystallization (after the recovery of crystalline sugar).

“Front-end fraction” refers to a fraction that is collected before the saccharose fraction in the chromatographic separation of a saccharose-containing liquid withdrawn from a beet sugar manufacturing process.

UF refers to ultrafiltration.

NF refers to nanofiltration.

RO refers to reverse osmosis.

“Retentate” and “concentrate” refer to the fraction that is retained by the membrane in a membrane filtration process.

“Permeate” refers to the fraction that is permeated through the membrane in a membrane filtration process.

The term “having a molar mass lower than about 50 kD” and the like expressions refer to compounds or mixtures of compounds which are obtainable by filtration through a membrane having the cut-off size of the indicated molar mass (50 kD, 10 kD, etc.). Due to the filtration technique, it is possible that a small amount of compounds having a higher molar mass is able to pass through the membrane, e.g. due to having an elongated form. The term should thus not be taken as being a 100% cut-off, but rather as indicating the general maximum (or minimum) size of the compounds in question.

“Desugarized” refers to a fraction of a sugar beet extract from which at least a major portion of the sugar contained in the feed solution has been removed. The term “non-sucrose” is used to denote a product lacking sucrose. The term “essentially non-sucrose” indicates that the product in question contains only a very small amount of sucrose, typically less than 5%.

“Debetainized” refers to a fraction of a sugar beet extract from which at least a major portion the betaine contained in the feed solution has been removed. The term “non-betaine” refers to a fraction which contains no betaine and the term “essentially non-betaine” indicates that the product contains very little betaine, typically less than 1%.

“Non-sucrose sweetener” refers to natural or artificial sweeteners other than saccharose. Such sweeteners include fructose, glucose, high fructose corn syrups, polyols, high intensity sweeteners, etc.

“Artificial sweeteners” refer to intense sweeteners typically selected from saccharin, aspartame, potassium acesulfame, sucralose, neotame, alitame and cyclamate.

A “reduced sugar” product refers to a sweetened product which has at least 25% less sugar sweetener per serving than a standard sugar-sweetened product.

An “essentially non-volatile” mixture refers in the context of the specification and claims to a mixture of sugar beet derived components which are not easily evaporated and which remain in solution even after evaporative operations at temperatures below 100° C., and especially at about 60 to 70° C.

An “amount which is effective” and “an effective amount” in context with the flavor improver of the present invention refers to an amount which, when included in an ingestible product, improves the organoleptic characteristics of said product in a significant way. The effective amount varies according to ingestible product and the route of production of the flavor improver. The amount is typically in the order of 1 to 2000 ppm, usually less than 200 ppm.

RDS refers to the refractometric dry substance content, calculated as saccharose and expressed as % by weight.

DS refers to the dry substance content, expressed as % by weight.

BS refers to beet sugar.

“Beet sugar” refers to crystalline sugar from sugar beet.

“Sugar” and “sucrose” refer to commercial crystalline saccharose manufactured either from sugar beet or sugar cane.

HFCS refers to high-fructose corn syrup.

PCA refers to pyrrolidone carboxylic acid.

D and kD refer to dalton and kilodalton (for molar mass).

“ppm” refers to a concentration expressed as mg of the dry weight of the flavor improver per liter or kilogram of the final product, if not otherwise stated.

### BRIEF DESCRIPTION OF THE INVENTION

It is thus an object of the present invention to provide a product based on a sugar beet extract, which is useful as a flavor improver in ingestible products, particularly in foodstuffs, and especially in beverages. It is a special object of the invention to improve the flavor of sweetened products and especially those sweetened with sweeteners other than sugar.

The flavor improver of the present invention comprises an essentially non-volatile mixture containing non-sucrose components of sugar beet extract. Said mixture is effective in enhancing the organoleptic characteristic(s) of ingestible products and it is obtainable by fractionation of said sugar beet extract.

In the preferred embodiment of the invention the non-sucrose components in combination are effective in enhancing the organoleptic characteristics.

The object of the present invention is also to provide a process for preparing the product, starting from various beet sugar process streams.

The process of the present invention comprises the steps of providing a sugar beet extract, fractionating said extract, and recovering a fraction comprising an essentially non-volatile mixture containing non-sucrose components of said sugar beet extract, which mixture is effective in enhancing the organoleptic characteristic(s) of ingestible products.

Furthermore, the object of the invention is to provide a method for enhancing the flavor of ingestible products, particularly foodstuffs, and especially beverages sweetened with sugar or sweeteners other than sugar.

The object of the invention is attained by the use of the flavor improver according to the invention in a nutritionally or pharmaceutically acceptable ingestible product in an amount which is effective in enhancing the organoleptic characteristics of said product.

The invention also covers sweetening compositions and ingestible products which contain said flavor improver product.

In connection with the present invention, said flavor improving especially refers to modifying the taste profile of an ingestible product sweetened with a reduced amount of sucrose or with a non-sucrose sweetener such as high-fructose corn syrup or artificial sweeteners so that the taste of said product will be closer to that of a corresponding product sweetened with sugar. The product of the invention is also useful as a general flavor modifier in foodstuffs.

The objects of the invention are achieved by products, processes and uses, which are characterized by what is stated in the independent claims. The preferred embodiments of the invention are disclosed in the dependent claims.

The invention is based on separating a product having the desired flavor-improving properties from various beet sugar process streams. The preferred embodiment of the invention is provided by using membrane filtration or chromatographic separation or combinations thereof.

The invention provides the advantage that a natural extract based on sugar beet can be obtained from easily available sugar process streams using straightforward techniques.

### BRIEF DESCRIPTION OF THE DRAWINGS

In the following the invention will be described in greater detail by means of preferred embodiments with reference to the attached drawings, in which

FIG. 1 is a graphical presentation of the chromatographic fractionation of the permeate obtained from the ultrafiltration of thick juice using a cut-off size of 10 kD described in Example 1B(3).

FIG. 2 is a graphical presentation of the chromatographic fractionation of molasses described in Example 1B(3).

### DETAILED DESCRIPTION OF THE INVENTION

The invention relates to a flavor improver based on a mixture of essentially non-volatile non-sucrose components of sugar beet extract. The preferred product of the invention comprises a mixture of compounds having a molar mass lower than about 50 kD. In a preferred embodiment of the invention, said compounds have a molar mass lower than about 10 kD.

The components of the mixture are typically non-volatile compounds, which are present in the sugar beet extract raw material. Such components include mainly inorganic salts, organic acids, trisaccharides and oligosaccharides, amino acids, peptides, and color compounds.

The salts derive from the sugar beet raw material and they typically comprise cations, such as Na⁺, K⁺, Ca²⁺, Mg²⁺ and Fe³⁺, and anions, such as SO₄²⁻, Cl⁻, NO₃⁻ and PO₄³⁻ The organic acids in the mixture are typically lactic acid, pyrrolidone carboxylic acid, acetic acid and citric acid. The most abundant of the trisaccharides is raffinose, even though a large part of the raffinose is preferably removed together with the sucrose. The amino acids are well represented in the mixture although their total amount is not large. The most abundant amino acids are typically glutamic acid and aspartic acid. Color compounds are typically included in the mixture and the preferred ones are those having a molar mass below 50 kD or more preferably below 10 kD. The color compounds give the product of the invention its brown color.

The product of the invention typically originates from a liquid withdrawn from a beet sugar manufacturing process. Said liquid may be any stream or fraction withdrawn from any stage of the beet sugar manufacturing process. In a typical embodiment of the invention, said liquid is selected from raw juice, thick juice and molasses. It may also be for instance an intermediary fraction withdrawn from the crystallization of sugar. Mixtures of said liquids may also be used. In a preferred embodiment of the invention, said liquid is thick juice or molasses.

In the preferred embodiment of the invention molasses is used as the starting liquid. Molasses is a liquid which is obtained as the residue after the crystallization of sucrose. It is abundantly available and is commonly used as feed for animals. When the desired fraction has been recovered from the molasses, the residue may still be used as a feed for animals. Thus, using molasses for providing a valuable flavor product is highly advantageous.

The product of the invention is obtainable by fractionation of a sugar beet extract. For fractionation, any separation techniques, such as membrane techniques, chromatography and extraction can be used. The separation or fractionation is preferably selected from crystallization, evaporation, chromatographic separation, membrane filtration and combinations thereof.

The fractionation process typically comprises membrane filtration or chromatographic fractionation or combinations thereof.

The fractionation process also typically includes at least one evaporation process, which removes volatile components of the beet extract.

The flavor improver of the invention is preferably produced from a sugar beet extract which has been desugarized and evaporated prior to the fractionation. The preferred sugar beet extract is molasses. The beet extract is either subjected to an ultrafiltration to remove compounds having a molar mass higher than 50 kD or to a chromatographic fractionation, or both.

In a batch chromatographic fractionation the flavor improver is obtained from the front-end fraction which typically is essentially free of saccharose and betaine. The chromatographic fractionation may also be performed in a continuous fractionation and in this case, the desired product is obtained as a combination of fractions which are mainly free of betaine and monosaccharides and preferably contain only low amounts of sucrose and raffinose.

It should be noted that the flavor improver of the invention contains a multitude of compounds deriving from the beet sugar process and which are other than saccharose, monosaccharides and betaine. The main components found in a chemical analysis are inorganic salts and organic acids (free or in salt form) in addition to any remaining sucrose and raffinose. It is believed that although these major compounds may play a role in providing the over-all flavor effect of the present invention, they are not alone responsible for the desired flavor enhancement. Indeed, it is believed that the flavor enhancement is due to a complex mixture of components, some of which are present in extremely low amounts.

It should further be noted that even though the mixture may contain large amounts of sucrose and raffinose, which are known to impart a sweet taste, it is not these components which provide the desired effect. Indeed, at the very low levels (1 to 2000 ppm and preferably below 200 ppm) that the flavor improver is added to foods, neither sucrose nor raffinose provide any noticeable taste at all. It is thus evident that it is the non-sucrose components of the sugar beet extract which in combination are effective flavor improvers and enhance the organoleptic characteristics of the ingestible products.

One embodiment of the invention relates to a product based on a sugar beet extract, which product is prepared by a process comprising, in any desired sequence, at least one membrane filtration and at least one chromatographic fractionation of a liquid withdrawn from a beet sugar manufacturing process, and recovering a product comprising a compound or a mixture of compounds having a molar mass lower than about 50 kD. In a preferred embodiment of the invention, said compounds have a molar mass lower than about 10 kD.

In one embodiment of the invention, the product of the invention is prepared by a process comprising membrane filtration of a liquid withdrawn from a beet sugar manufacturing process to obtain a retentate and a permeate, recovering said permeate, chromatographic fractionation of said permeate to obtain a front end fraction and at least one other fraction, and recovering said front end fraction.

Said membrane filtration may be selected from ultrafiltration, nanofiltration, reverse osmosis, electrodialysis and combinations thereof.

In a typical embodiment of the invention, said membrane filtration comprises ultrafiltration. The cut-off size of the ultrafiltration membrane is selected depending on the molar mass of the desired compounds to be recovered. For example, to obtain a fraction including compounds with a molar mass lower than about 50 kD, an ultrafiltration membrane with a cut-off size of 50 kD is selected, whereby the desired compounds are recovered in the ultrafiltration permeate. To obtain a fraction including compounds with a molar mass lower than about 10 kD, an ultrafiltration membrane with a cut-off size of 10 kD is selected, whereby the desired compounds are also recovered in the ultrafiltration permeate. The sugar beet extract may also be filtered through an ultrafiltration membrane with a cut-off size smaller than 10 kD, for example 2 kD. In this case desired compounds may be recovered either in the ultrafiltration retentate or permeate.

Several types of ultrafiltration membranes can be used in the membrane filtration. These include tubes, spirals and plates. The material of the membrane may be selected from polymeric material (such as polypropylene, polysulfone and polyvinylidene fluoride), stainless steel, ceramics and carbon, for example. The ultrafiltration is preferably carried out using cross-flow (or tangential flow) of the feed liquid over the membrane. The ultrafiltration is typically followed by diafiltration.

The membrane filtration process for obtaining the product of the invention may also comprise one or more nanofiltration steps.

In the same way as in the ultrafiltration, the cut-off size of the nanofiltration membrane is selected depending on the molar mass of the desired compounds to be recovered. For instance, to obtain a fraction including compounds with a molar mass higher than about 500 D, a nanofiltration membrane with a cut-off size of 500 D is selected, whereby the desired compounds are recovered in the nanofiltration retentate.

The nanofiltration membranes may be selected from polymeric and inorganic membranes. Typical polymeric nanofiltration membranes useful in the present invention include, for example, polyether sulfone membranes, sulfonated polyether sulfone membranes, polyester membranes, polysulfone membranes, aromatic polyamide membranes, polyvinyl alcohol membranes and polypiperazine membranes and combinations thereof. The form of the mebrane may be selected for example from tubes, spiral membranes and hollow fibers. Before the nanofiltration procedure, the nanofiltration membranes may be pretreated with alkaline detergents or ethanol, for example.

The nanofiltration is typically carried out at a pressure of 10 to 50 bar, preferably 15 to 35 bar.

The ultrafiltration or nanofiltration equipment useful in the present invention comprises at least one ultrafiltration/nanofiltration membrane element dividing the feed into a retentate and a permeate. The equipment typically also includes means for controlling the pressure and flow, such as pumps and valves and flow and pressure meters and controllers. The equipment may also include several ultrafiltration or nanofiltration elements in different combinations arranged in parallel or series.

Before the membrane filtration step, the solution to be treated may be subjected to one or more pre-treatment steps, such as filtration to remove the insoluble components, concentration and/or dilution. The solution may also be treated by ion exchange and/or carbonation procedures known in the art.

In one embodiment of the invention, the product of the invention may be prepared by a process comprising at least two membrane filtration steps. Said membranes typically have a different cut-off size in each step.

As an example of this embodiment of the invention, the first membrane filtration is carried out with a membrane having a cut-off size of 10 kD, the permeate including compounds having a molar mass lower than about 10 kD is recovered and subjected to a second membrane filtration with a cut-off size of 2 kD to obtain a retentate including compounds with a molar mass higher than 2 kD, but lower than 10 kD.

In one embodiment of the invention, the product of the invention is prepared by a process that further comprises at least one evaporation step before, after or between said membrane filtration and chromatographic fractionation steps. The evaporation is typically carried out at a reduced pressure and at a temperature below 100° C., such as 40 to 85° C., preferably 50 to 70° C., typically at about 60° C. The evaporation increases the concentration of the solution but it also removes volatile components. The effect of the product of the invention is thus not dependent on the presence of the volatile components of a beet extract.

In one embodiment of the invention, the product of the invention is prepared by a process further including at least one chromatographic fractionation step.

Said chromatographic fractionation is typically carried out in a column filled with a column packing material. In the chromatographic fractionation of the present invention, said column packing material may be selected from cation exchange resins. Said cation exchange resins may be selected from strongly acid cation exchange resins and weakly acid cation exchange resins. The resin may be in a monovalent metal form, such as in Na⁺ and K⁺ form. The resin may also be in a divalent metal form, such as in Ca²⁺, Mg²⁺ or Sr²⁺ form.

Said chromatographic fractionation may also be carried out using a column packing material selected from anion exchange resins. The anion exchange resins may be selected from weakly basic anion exchange resins, for example.

The resins may have a styrene skeleton or acrylic skeleton, for example. These may be crosslinked with divinylbenzene. The cross-linking degree is typically from about 1 to about 20% divinylbenzene, preferably from about 3 to about 8% divinylbenzene.

The average particle size of the chromatographic separation resin is normally 10 to 2000 μm, preferably 100 to 400 μm.

The eluent used in the chromatographic fractionation is preferably water, but even solutions of salts and water are useful.

The temperature of the chromatographic fractionation depends on the selected resin, for instance. The temperature is typically in the range of 50 to 100° C., preferably 55 to 90° C.

The chromatographic fractionation may be carried out as a batch process or a continuous process. The continuous process is typically carried out as a simulated moving bed process.

In a simulated moving bed process, the chromatographic fractionation is typically carried out using 3 to 14 columns connected in series. The columns are interconnected with pipelines. The flow rate in the columns is typically 0.5 to 10 m³/(hm²) of the cross-sectional area of the column. Columns are filled with a column packing material selected for example from those mentioned above. The columns are provided with feed lines and product lines so that the feed solution and eluent can be fed into the columns and the product fractions collected from the columns. The product lines are provided with on-line instruments so that the quality/quantity of the production can be monitored during operation.

It is obvious to a person skilled in the art that the resins and procedures used for the chromatographic fractionation may be varied for instance as mentioned above or in some other way and that the manner in which the components will be fractionated depends on the conditions used. Thus, the peaks of the various components and the position(s) of the desired fraction(s) in the fractionation profile may vary. For the present invention it is not decisive how the desired flow improving fraction is obtained. The person skilled in the art will be able to optimize the procedure in many ways without departing from the gist of the invention.

Before the chromatographic fractionation, the feed solution may be subjected to one or more pre-treatment steps selected from softening by ion-exchange treatment or carbonatation, dilution, concentration e.g. by evaporation, pH adjustment and filtration, for example. The chromatographic fractionation provides a front-end fraction and at least one other fraction. In a typical embodiment of the invention, the front-end fraction, i.e. the fraction that elutes first (before the saccharose fraction) from the column comprises the desired product of the invention. It is predominantly composed of salts and compounds with a molar mass different from that of saccharose. Compounds with a molar mass higher than that of saccharose include for example trisaccharides and oligosaccharides, color compounds and other macromolecules present in sugar beet. The main cations of said salts are selected from sodium, potassium and calcium and the main anions of said salts are selected from sulphate, chloride, nitrate, phosphate and oxalate.

The mixture of the flavor improver typically contains organic acids selected from lactic acid, pyrrolidone carboxylic acid (PCA), acetic acid, citric acid, and mixtures thereof. The organic acids typically comprise a total of 45 to 5%, preferably 35 to 10% calculated on the dry substance.

The mixture preferably contains very little saccharose and/or raffinose since if these compounds are provided in abundance, they are believed to mask the active flavor components which are included in the mixture in small amounts. Thus, the saccharose is preferably removed almost totally, and the raffinose is preferably provided at a level of about 4-6% on the dry substance. However, the mixture may contain raffinose and/or sucrose in an amount of up to 60%, preferably less than 20%, most preferably less than 10% calculated on the dry substance.

The mixture is also substantially free of monosaccharides and it typically contains less than 1%, preferably less than 0.5% of each of glucose and fructose calculated on the dry substance. The mixture also includes a small amount of amino acids like aspartic acid and glutamic acid and some neutral amino acids. Typically, the mixture contains less than 5%, preferably less than 3% of amino acids calculated on the dry substance.

Betaine is a component of beet extract which has a bitter taste and which is preferably not included in the mixture. Thus, the fraction providing the desired flavor improver preferably contains less than 1% betaine, preferably less than 0.5% betaine calculated on the dry substance.

The mixture also contains color compounds, preferably color compounds having a molar mass below 50 kD, and even more preferably below 10 kD. These color compounds give the mixture a dark color.

The chromatographic fraction which does not provide the desired flavor improver, typically comprises two fractions: a fraction containing saccharose, part of other carbohydrates, including glucose and fructose, and some amino acids, and a fraction containing betaine, carbohydrates, including glucose and fructose, and some amino acids.

For some purposes, it is also possible to use blends of said fractions or blends of one of said fractions with one or more components from other fractions.

After the chromatographic fractionation, the fraction(s) recovered may be subjected to various after-treatment steps, such as treatment with activated carbon, e.g. to reduce color. Color compounds may typically be removed also by adsorption or membrane filtration.

If only membrane filtration is used for the fractionation, the composition of the mixture is slightly different from that discussed above. However, also the membrane filtration should be performed so as to recover a substantially desugarized mixture of compounds from which high molar mass color and taste compounds (above 50 kD) have been removed. Such a product is provided, for instance, by ultrafiltration of molasses.

In a preferred embodiment of the invention, the product of the invention is prepared by a process wherein said chromatographic fractionation is carried out using a column packing material selected from strongly acid cation exchange resins in a monovalent metal form, preferably in Na⁺ form. The resin is supported on a styrene skeleton crosslinked with divinyl benzene.

In one specific embodiment of the invention, the invention provides a product based on a sugar beet extract comprising

a compound or a mixture of compounds having a molar mass lower than about 10 kD, and which product is prepared by a process comprising

ultrafiltration of thick juice withdrawn from a beet sugar manufacturing process using an ultrafiltration membrane having a cut-off size of up to about 10 kD to obtain a permeate and a retentate,

recovering said permeate,

chromatographic fractionation of said permeate to obtain a front-end fraction and at least one other fraction,

and recovering said front-end fraction.

In another specific embodiment of the invention, the invention provides a product based on a sugar beet extract comprising

a compound or a mixture of compounds having a molar mass lower than about 10 kD, and which product is prepared by a process comprising

providing thick juice from a beet sugar manufacturing process,

removing insoluble components from said thick juice,

ultrafiltration of said thick juice, from which the insoluble components have been removed, using an ultrafiltration membrane having a cut-off size of up to 10 kD to obtain a permeate and a retentate,

recovering said permeate,

concentrating said permeate,

chromatographic fractionation of said concentrated permeate to obtain a front-end fraction and at least one other fraction,

recovering said front-end fraction, and

concentrating said front-end fraction.

Said concentration is typically carried out by evaporation. A typical evaporation will provide a product having a concentration of 35 to 70% (DS).

In a further embodiment of the invention, the invention provides a product based on a sugar beet extract comprising a compound or a mixture of compounds having a molar mass lower than about 50 kD, and which product is prepared by a process comprising chromatographic fractionation of molasses to obtain a front-end fraction and at least one other fraction, and recovering said front-end fraction.

The invention also provides a product based on molasses, which product is prepared by a process comprising chromatographic fractionation of molasses withdrawn from a beet sugar manufacturing process to obtain a front-end fraction and at least one other fraction, and recovering said front-end fraction. The process of obtaining a product based on molasses may also comprise one or more membrane filtration steps before or after the chromatographic fractionation. In one embodiment of the invention, the process comprises ultrafiltration after the chromatographic fractionation. In another embodiment of the invention, the process comprises only ultrafiltration of the molasses without chromatographic fractionation. The ultrafiltration is typically carried out using an ultrafiltration membrane of up to 10 kD, and the ultrafiltration permeate is recovered. However, ultrafiltration of molasses for a cut off of 50 kD or 2 kD also give useful products. Furthermore, the process may also comprise a concentration step before or after the chromatographic fractionation and/or before or after the membrane filtration. The concentration is typically carried out by evaporation.

In another specific embodiment of the invention, the invention provides a product based on a sugar beet extract comprising

a compound or a mixture of compounds having a molar mass lower than about 10 kD, and which product is prepared by a process comprising

providing molasses from a beet sugar manufacturing process,

pretreating said molasses by filtering, carbonation and/or ion exchange,

ultrafiltration of said pretreated molasses using an ultrafiltration membrane having a cut-off size of up to 10 kD to obtain a permeate and a retentate,

recovering said permeate,

concentrating said permeate,

chromatographic fractionation of said concentrated permeate to obtain a front-end fraction and at least one other fraction,

recovering said front-end fraction, and

concentrating said front-end fraction.

Said concentration is typically carried out by evaporation or by reverse osmosis or both.

In yet another embodiment of the invention, the invention provides a product obtained from molasses, wherein said chromatographic separation is performed before said ultrafiltration step to provide a product having a molar mass lower than about 10 kD.

The invention also relates to a process for producing the edible flavor improver of the invention. The process comprises the steps of providing a sugar beet extract, fractionating said extract, and recovering a fraction comprising an essentially non-volatile mixture containing non-sucrose components of said sugar beet extract which mixture is effective in enhancing the organoleptic characteristic(s) of ingestible products, especially sweetened ingestible products.

The fractionation is typically crystallization, evaporation, chromatographic separation, membrane filtration or a combination thereof. Crystallization is mainly used for removal of sucrose before the actual fractionation is started. Evaporation is used to concentrate the extract and/or the product.

The evaporation also removes components of the extract and/or the product, thus causing the final product to comprise mainly non-volatile components of the sugar beet extract. Chromatographic separation removes i.a. betaine and monosaccharides but also some or all of the sucrose remaining in the solution. Raffinose may similarly be removed by chromatographic fractionation.

Membrane filtration includes mainly ultrafiltration or nanofiltration and serves to remove very large or very small molecules from the mixture.

The process may be used for preparing a product based on a sugar beet extract comprising a compound or a mixture of compounds having a molar mass lower than about 50 kD. The preferred process comprises at least one membrane filtration and/or least one chromatographic fractionation, in any desired sequence, of a liquid withdrawn from a beet sugar manufacturing process, and recovering a product comprising a compound or a mixture of compounds having a molar mass lower than about 50 kD.

The preferred embodiments of the process as well as a detailed description of the realization of the process are the same as set forth above in connection with the description of the product of the invention.

The invention also relates to the use of the product of the invention as a flavor improver in ingestible products, particularly in foodstuffs, and especially in sweetened foodstuffs, which are sweetened with a reduced amount of sugar or with a sweetener other than sugar. Said foodstuffs are typically sweetened with fructose, high-fructose corn syrup or artificial sweeteners. Said artificial sweeteners are typically selected for example from saccharin, aspartame, potassium acesulfame, sucralose, neotame, alitame, cyclamate, and polyols. The polyols comprise xylitol, sorbitol, lactitol, maltitol, mannitol and erythritol, for example.

The product of the invention is typically used in diet and low-calorie foodstuffs sweetened with above-mentioned sweeteners other than sugar. The flavor improver of the invention may also be used in products sweetened with sugar. Especially products having a reduced amount of sugar, e.g. for low calorie purposes, may have their sweetness and mouthfeel enhanced by the product of the present invention. The flavor improvers of the invention are also advantageous in diabetic foods, which are typically sweetened with reduced amounts of sugar or with fructose or artificial sweeteners.

An especially important field of use of the product of the present invention consists of beverages and concentrates and syrups thereof. Said beverages are typically selected from soft drink beverages, especially flavored soft drink beverages, such as cola drinks. The beverages also include sports drinks, diet drinks, juices, tea, coffee, beer and flavored alcoholic beverages.

When the beverage is a diet soft drink sweetened with a non-sucrose sweetener, the flavor improver can be used to bring the taste of the diet soft drink closer to the taste of a corresponding sucrose sweetened soft drink. The flavor improver is especially suited for masking bitter taste and the “metallic” taste of many artificial sweeteners.

If the beverage is beer or a flavored alcoholic drink, the flavor improver may be used to reduce the bitterness, acidity and/or alcohol burn taste of the drink. It is a special feature of the flavor improver of the invention, that when added to beer, it will make the drink softer or more palatable to some consumers and particularly to female consumers.

The flavor improver has the capacity of improving and enhancing the organoleptic characteristics of nutritional and/or pharmaceutical ingestible products. The flavor improver typically provides a sugar-like taste even when no sugar is present. It increases the ripeness taste of fruit flavor, reduces acidity, bitterness and/or sharpness, increases sweetness and prolongs the sweet taste, improves texture and mouth feel, and provides a pleasant after taste. The flavor improver may be used in a great variety of products and with a great variety of sweeteners or blends of sweeteners. Depending on the product and the sweetener, the flavor improver may improve and enhance different flavors of the product and sweetener in question. The person skilled in the art will be capable of optimizing the amount of flavor improver to be used together with any given product and sweetener.

Examples of foodstuffs where the product of the invention can be used are processed foods and vegetables, soups, sauces, condiments, breakfast cereals, salad dressings, savory, soy based products, juices, syrups, jams, marmalades, desserts, ice cream, confections, chocolate products, and dairy products, such as yogurts, fruit and berry products, bakery products, and sweetened pharmaceuticals. The specific ripe fruit flavor can suitably be utilized in jams, marmalades, fruit flavored yogurts, fruit drinks, ice creams, confectionery and fruit desserts.

The flavor improver product of the invention is added to foodstuffs in amounts imparting the desired flavoring effect to said foodstuff. The flavor improver is typically used in any ingestible product in an amount between 1 and 2000 ppm, preferably 5 to 500 ppm, most preferably 10 to 200 ppm calculated as dry substance.

The invention also relates to sweetening compositions including the product of the invention in combination with one or more other sweeteners, such as those mentioned above.

Furthermore, the invention relates to ingestible products, especially foodstuffs and particularly beverages including the product of the invention. Said foodstuffs are typically sweetened foodstuffs sweetened with reduced sugar, fructose, high-fructose corn syrup or artificial sweeteners, such as saccharin, aspartame, potassium acesulfame, sucralose, neotame, alitame, cyclamate and polyols. Said polyols are typically selected from xylitol, sorbitol, lactitol, maltitol, mannitol and erythritol. In a preferred embodiment of this aspect of the invention, said foodstuffs are selected from beverages and concentrates and syrups thereof. Especially, said beverages are selected from cola drinks. Said foodstuffs contain the product of the invention in amounts imparting the desired flavoring effect to said foodstuffs.

In one aspect of the invention, the invention also relates to pharmaceutical compositions including the product of the invention.

The invention also relates to methods of improving the flavor of ingestible products, especially foodstuffs, by adding the product of the invention to said ingestible product. Said ingestible products are especially food-stuffs and particularly beverages sweetened as mentioned above.

The following examples are illustrative examples of the invention, without limiting the invention in any way.

### EXAMPLE 1

In the process scheme for carrying out the separation process of Example 1, the general sugar manufacturing process starts from sugar beets. Sliced sugar beet is subjected to extraction to extract the sugar from beets. The sugar-containing juice is subjected to purification by conventional methods, followed by evaporation. The evaporated sugar solution is subjected to crystallizations to obtain the sugar product.

A raw juice stream is provided after the extraction step, a thick juice stream is provided after the evaporation step and a molasses stream is obtained from the crystallizations. Raw juice, thick juice and molasses, respectively, are subjected to various membrane filtration and/or chromatographic fractionation steps. The membrane filtration stages (UF, NF) and chromatographic fractionation stages provide their respective fractions obtained the in membrane filtrations and chromatographic fractionations. The fractions so obtained are then subjected to final evaporation stages. The realization of the membrane filtration and chromatographic fractionation is described in detail hereinafter.

### EXAMPLE (1A)

Membrane Filtration (Ultrafiltration and Nanofiltration)

1A(1) The Feeds for the Membrane Filtration:

The feeds used for the membrane filtration were raw juice and thick juice obtained from a beet sugar manufacturing process comprising an extraction step, a sugar juice purification and evaporation step and crystallization. The extraction, purification and evaporation steps as well as the crystallization were carried out by conventional methods known in the field of beet sugar manufacture.

The samples of raw juice and thick juice were pretreated by filtering to remove insoluble components and other impurities.

1A(2) Ultrafiltration:

Raw juice and thick juice obtained from a sugar manufacturing process as described above were subjected to ultrafiltration using a pilot-scale ultrafiltration equipment having membranes with a spiral form. Ultrafiltration membranes with different cut-off values (2 kD, 10 kD, 30 kD and 50 kD) were used. The ultrafiltration membranes were GR type membranes manufactured by DSS, Denmark. The ultrafiltration also included diafiltration. The membranes were cleansed and rinsed according to conventional methods. Before ultrafiltration, the thick juice was pretreated by diluting with a suitable quantity of deionized water and heated to 60° C., until RDS of the thick juice feed was approximately 30%. The raw juice was used as it was. The thick juice feed thus obtained and the raw juice feed in its original form were filled into the UF unit.

The ultrafiltration was carried out at 60° C. using a pressure of 3 to 4 bar. The pressure difference over the membranes was 1.5 bar. After recirculation for 5 minutes in the UF unit, 300 liters of thick juice permeate and 1000 liters of raw juice permeate were collected. The permeates obtained from the ultrafiltration were evaporated in a vacuum evaporator at a temperature of 70° C. to an RDS of 66 to 72% (for chromatographic fractionations).

While the permeate of the ultrafiltration was concentrated by evaporation, the remaining liquid in the UF unit was diafiltered with deionized water. The operation was continued until RDS in the permeate was below 0.1%. Before diafiltration, the volume was reduced to minimum.

The concentrate (from the ultrafiltration) was transferred into an RO unit (0.7 m²) with lab 20 (HR98) membranes and concentrated at 60° C. to a flux of zero.

1A(3) Nanofiltration:

Some of the ultrafiltration permeates obtained from the ultrafiltration as described above were further subjected to nanofiltration (see Table 1 hereinafter). Nanofiltration was carried out with a DSS 30-19 nanofiltration module having FT 50 nanofiltration membranes (manufactured by Dow Chemicals, USA). The surface area of the membranes was 19 m². The nanofiltration also included diafiltration. The nanofiltration was started with a large quantity of the feed diluted to a dry substance content (RDS) of 10%. The nanofiltration operation was carried out at 50° C. and with a pressure of 20 bar on the membranes. The operation was stopped when the dry substance content (RDS) of the concentrate reached 20% or the flux became too low. The retentate was collected in such a quantity that it was possible to concentrate it. The diafilteret retentates and the permeates obtained from the nanofiltration were evaporated in the same way as the ultrafiltration permeates above for chromatographic fractionations, some amount were too small for reaching high dry substance concentrations in the evaporator.

1A(4) Analysis on the Feeds, Concentrates and Permeates of the Membrane Filtrations:

The following analyses were made on the feeds, concentrates and permeates of the membrane filtrations: RDS, pH, color, purity, ash and DS.

The results of the membrane filtration tests are presented in the following Table 1, where

“RDS” refers to the refractometric dry substance content, expressed as % by weight,

“Color” has been measured by the ICUMSA method and expressed as ICUMSA units,

“Purity” refers to the apparent saccharose purity expressed as % by weight on the dry substance (kg saccharose per kg dry substance),

“Ash” refers to the conductivity ash content, measured by ICUMSA method,

DS refers to the dry substance content measured by drying in the oven at 105° C., expressed as % by weight.

TABLE 1
Membrane filtration results

| | | | | | Analysis of the evaporated products | | | | | | Analysis of the feed | | | | |
|---|---|---|---|---|---|---|---|---|---|---|---|---|---|---|---|
| Feed | Process | | | Type | RDS | pH | Color | Purity | Ash | DS | DS | pH | Color | Purity | Ash |
| Thick juice | none | A | | | 68.54 | 8.6 | 1390 | 94 | 2.2 | | | | | | |
| ″ | UF 2 kD | B | B | concentrate | 3.2 | 7.3 | 51100 | | | 3.06 | 70.52 | 8.48 | 1108 | 93.76 | 2.2 |
| | | 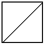 | B | permeate | 70.82 | 8.3 | 1244 | 94.38 | 2.2 | | | | | | |
| ″ | UF 10 kD | | C | concentrate | 2.57 | 8.4 | 32900 | | | 2.51 | 72.2 | 8.95 | 1288 | 94.6 | 2.22 |
| | | 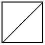 | C | permeate | 71.54 | 8.9 | 1685 | 94.39 | 2.2 | | | | | | |
| ″ | UF 50 kD | | D | concentrate | 8.55 | 8.7 | 1800 | | | 8.8 | 68.54 | 8.61 | 1390 | 94 | 2.2 |
| | | 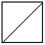 | D | concentrate | 69.28 | 8.6 | 1182 | 93.91 | 2.2 | | | | | | |
| Type C | NF 300 D | | F | concentrate | 65.22 | 8.7 | 1770 | 91.64 | 3.87 | | 72.9 | 8.71 | 1240 | 94.2 | 2.35 |
| Permeate | | 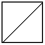 | F | permeate | 18.6 | 9.4 | 3230 | 59.3 | 21.0 | | | | | | |
| Type C | NF 300 D | | F | concentrate | 69.06 | 8.6 | 1393 | 94.19 | 2.25 | | 70.54 | 8.89 | 1694 | 93.74 | 2.51 |
| Permeate | | 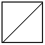 | F | permeate | 46.62 | 9.6 | 2880 | 67.98 | 12.2 | | | | | | |
| Raw juice | none | | H | | | | | | | | 13.35 | 6.09 | | 93.6 | 2.8 |
| UF 30 kD | | | I | permeate | 68.22 | 6.0 | 1956 | 91.66 | 2.7 | | 13.11 | 5.97 | 1480 | 93.4 | 2.8 |
| | | 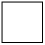 | I | | | | | | | | | | | | |
| Type I | UF 2 kD | | J | concentrate | 1.59 | 6.1 | 3710 | | | 1.59 | 14.03 | 5.83 | 1450 | 90.45 | 2.5 |
| Permeate | | 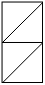 | J | permeate | 68.52 | 6.0 | 1275 | 93.14 | 2.23 | | | | | | |
| | UF 10 kD | | K | concentrate | 3.09 | 6.6 | 100800 | | | 3.06 | 14.01 | 5.7 | 12.55 | 92.58 | 2.8 |
| | | 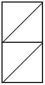 | K | permeate | 69.42 | 5.9 | 1590 | 92 | 2.31 | | | | | | |
| Type K | NF 300 D | | M | concentrate | 67.86 | 4.9 | 4008 | 93.49 | 1.91 | | 13.82 | 5.1 | 1221 | 93.2 | 2.57 |
| Permeate | | 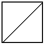 | M | permeate | 64.37 | 6.2 | 11060 | 65.37 | 16.2 | | | | | | |

1A(5) Additional Results of Ultrafiltration Tests

Ultrafiltration of six consecutive batches of thick juice was carried out using an ultrafiltration membrane with a cut-off size of 10 kD. Permeates from the ultrafiltration were collected. After ultrafiltration, the permeates were subjected to evaporation at 70° C. to a dry substance content of 66 to 69% as described above. The ultrafiltration conditions were: temperature, 62 to 70° C., inlet pressure, 3 to 4 bar, and pressure drop 1.5 bar. Table 2 shows the analysis results of the feeds and the evaporated permeates.

TABLE 2
Results of ultrafiltration tests made for six consecutive batches
of thick juice with UF 10 kD membrane

| | | Analysis of the evaporated products | | | | | | Analysis of the feed | | | | |
|---|---|---|---|---|---|---|---|---|---|---|---|---|
| Thick juice | Process | Batch | RDS | pH | Color | Purity | Ash | RDS | pH | Color | Purity | Ash |
| Type C | UF 10 kD | 1 | 69.92 | 8.76 | 1440 | 94.9 | 1.80 | 71.66 | 8.86 | 1765 | 93.7 | 1.97 |
| Permeate | | 2 | 70.18 | 8.56 | 1320 | 94.9 | 1.93 | 70.22 | 8.59 | 1745 | 93.8 | 1.99 |
| | | 3 | 70.86 | 9.25 | 1480 | 94.5 | 2.02 | 74.46 | 9.40 | 1990 | 94.0 | 2.07 |
| | | 4 | 67.64 | 9.17 | 1330 | 95.1 | 1.84 | 72.46 | 9.16 | 1920 | 94.4 | 1.94 |
| | | 5 | 68.78 | 8.97 | 1360 | 95.0 | 1.97 | 69.42 | 8.97 | 1895 | 94.3 | 2.05 |
| | | 6 | 69.24 | 9.42 | 1390 | 95.2 | 1.98 | | | | | |
| Average | | | 69.44 | 9.02 | 1387 | 94.9 | 1.92 | 71.64 | 9.00 | 1863 | 94.0 | 2.00 |

### EXAMPLE (1B)

Chromatographic Fractionation

The evaporated permeates or retentates obtained from the membrane filtrations described above (permeates from the ultrafiltration and retentates from the nanofiltration) as well as molasses were subjected to chromatographic fractionation.

1B(1) Fractionation of the Ultrafiltration Permeates and Nanofiltration Retentates Obtained From the Ultrafiltration/Nanofiltration of Thick Juice and Raw Juice:

The column packing material in the chromatographic fractionation was Dowex monosphere 99K350 resin manufactured by Dow Chemicals, USA (a strongly acid cation exchange resin in Na⁺ form) with a bead size of 0.37 mm.

The chromatographic fractionations were done in a 200-liter column (inner diameter 0.225 m) using water as the eluent. The separation conditions were the following:

| | |
|---|---|
| Resin bed height | 5.5 m |
| Feed size | 12 l |
| Feed RDS | 35 g/100 g |
| Temperature | 80° C. |
| Flow rate | 30 l/h |

Four different feed solutions (four concentrates/permeates obtained from the ultrafiltrations/nanofiltrations described above) were subjected to chromatographic fractionation. From each chromatographic fractionation, three fractions were collected. The first fraction (fraction no 1=front-end fraction) contained macromolecules (including color compounds) and salts, the second fraction (fraction no 2) contained sucrose, part of carbohydrates, including glucose and fructose, and some amino acids, and the third fraction (fraction no 3) contained betaine, carbohydrates, including glucose and fructose, and some amino acids.

The first feed solution (sample no 6) was a permeate obtained from the ultrafiltration with a cut-off size of 2 kD of thick juice (type B ultrafiltration permeate in Table 1). Three fractions numbered as 6.1, 6.2 and 6.3 (separated with a 200-liter column) were collected from the chromatographic fractionation.

The second feed solution (sample no 3) was a permeate obtained from the ultrafiltration with a cut-off size of 10 kD of thick juice (type C ultrafiltration permeate in Table la). Three fractions numbered as 3.1, 3.2 and 3.3 (separated with a 200-liter column) were collected from the chromatographic fractionation.

The third feed solution (sample no 17) was a concentrate (=retentate) obtained from the nanofiltration with a cut-off size of 300 D of the permeate from the ultrafiltration with cut-off size of 10 kD of thick juice (type F nanofiltration concentrate from type C ultrafiltration permeate in Table 1). Three fractions numbered as 17.1, 17.2 and 17.3 (separated with a 200-liter column) were collected from the chromatographic fractionation.

The fourth feed solution (sample no 18) was a concentrate obtained from the nanofiltration with a cut-off size of 300 D of the permeate from the ultrafiltration with a cut-off size of 10 kD of raw juice (type M nanofiltration concentrate from type C ultrafiltration permeate in Table 1). Three fractions numbered as 18.1, 18.2 and 18.3 (separated with a 200-liter column) were collected from the chromatographic fractionation.

The front-end fractions (6.1, 3.1, 17.1 and 18.1 having an RDS of 0.6 to 0.8%) were evaporated in a thin film evaporator at a temperature of 45° C. and at a vacuum of 0.92 bar to an RDS of 13.2% and subjected to organoleptic analysis (see Examples 2(B) and 2(C).

1B(2) Additional Chromatographic Fractionation of the Ultrafiltration/Nanofiltration Permeates/Retentates Obtained From Thick Juice and Raw Juice:

Sample no 6 mentioned above (type B ultrafiltration permeate in Table 1) and sample no 3 mentioned above (type C ultrafiltration permeate in Table 1) were subjected to further chromatographic fractionation. The chromatographic separation resin was the same as in chromatographic fractionation 1B(1) above. The separation was done in a 10-liter column with an inner diameter of 10 cm using the following separation conditions:

| | |
|---|---|
| Resin bed height | 166.2 cm |
| Feed size | 800 ml |
| Feed RDS | 35 g/100 g |
| Temperature | 80° C. |
| Flow rate | 50 ml/min |

Five fractions were collected from each separation. The partial front-end fractions from the 10-liter column were numbered as 6.11, 6.12, 6.13 and 3.11, 3.12, 3.13, respectively, while the later fractions were numbered correspondingly 6.2, 6.3, 3.2 and 3.3. The fractions were evaporated approximately to a dry matter content of 38% (based on RDS) using the same evaporation conditions as in Example 1 B(1) and subjected to organoleptic analysis (see Example 2(E)).

1 B(3) Chromatographic Fractionation of a Thick Juice Permeate (Obtained From the Ultrafiltration of Thick Juice With a Membrane Having a Cut-off Size of 10 kD) and Molasses (Followed by Concentration With Evaporation or Reverse Osmosis):

In this separation, two feed solutions were used. The first feed solution was a solution referred to as sample no 3 above (type C ultrafiltration permeate=a permeate obtained from the ultrafiltration of thick juice with a cut-off size of 10 kD). The second feed solution was molasses referred to as m.

A strongly acid cation exchange resin in Na⁺ form (Finex CS GC, bead size 0.35 mm, manufacturer Finex Oy, Finland) was used as the separation resin. The separation was done in a 200-litre column (inner diameter 22.5 cm) using the following separation conditions using water as the eluent:

| | |
|---|---|
| Resin bed height | 5 m |
| Feed size | 12 l |
| Feed RDS | 35.4 g/100 g |
| Temperature | 80° C. |
| Flow rate | 30 l/h |

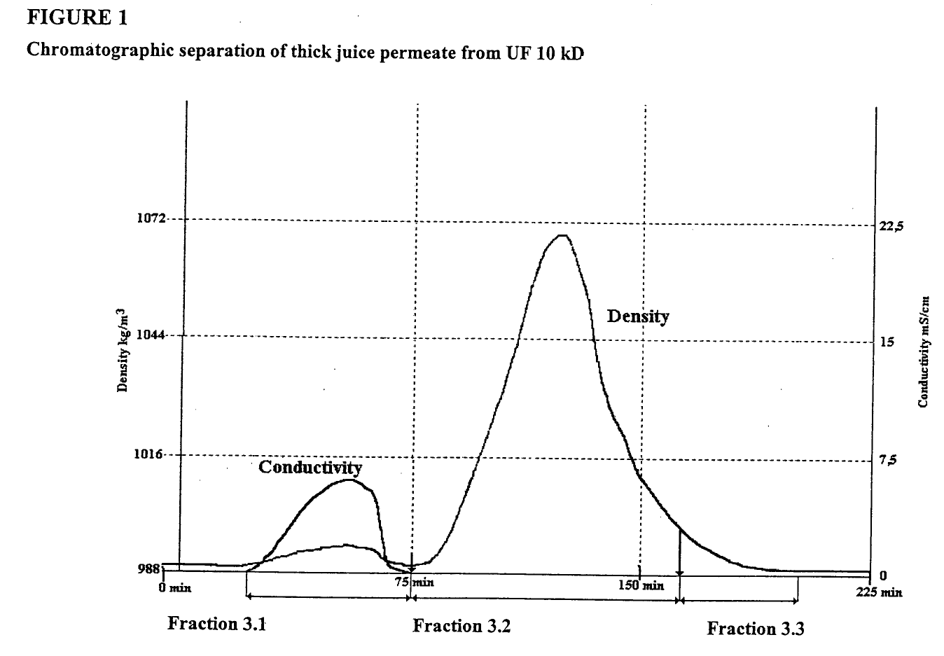

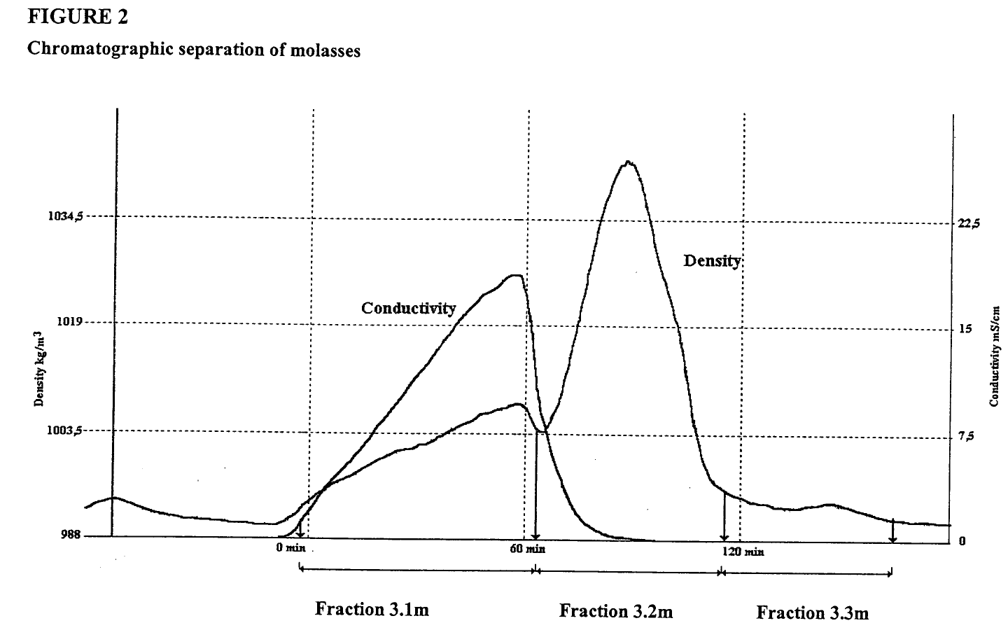

The results of the chromatographic fractionation of thick juice permeate from UF 10 kD is presented in FIG. 1, and the results of the chromatographic fractionation of molasses is presented in FIG. 2. FIGS. 2 and 2 show the conductivity and density profiles of each separation (in the figures, conductivity is expressed as mS/cm). FIGS. 1 and 2 also show the three fractions collected from each separation (fractions 3.1, 3.2 and 3.3 in FIG. 1 and fractions 3.1m, 3.2m and 3.3m in FIG. 2. The first fraction (the front-end fraction) from the chromatographic fractionation of thick juice permeate is called fraction 3.1. The first fraction from the chromatographic fractionation of molasses is called fraction 3.1m. Fraction 3.1 had an RDS of 0.6% and fraction 3.1m had an RDS of 2.6%.

The fractions 3.1 and 3.1m thus obtained were each divided into half. The first half was evaporated to a RDS of 35% using the same evaporation conditions as in Example 1B(1). The second half was concentrated by using reverse osmosis.

In the concentration of fraction 3.1 by reverse osmosis, 122 liters of fraction 3.1 (RDS 0.6, pH 5.08, conductivity 3.57 mS/cm) were processed into 2.5 liters of RO concentrate. The concentration by RO was made using a pressure of 54 to 58 bar and a temperature of 11.0 to 15.0° C. In the beginning (RDS 0.6, 11° C., 54 bar), the flux was 0,99 l/min (81.8 l/m²/h); and at the end (RDS 17, 15° C., 58 bar), the flux was 0.007 l/min (0.61 l/m²/h).

In the concentration of fraction 3.1m by reverse osmosis, 175 liters of fraction 3.1m (RDS 2.6), pH 4.9, conductivity 12.9 mS/cm) were processed into 23 liters of RO concentrate. The concentration by RO was made under a pressure between 52 to 58 bar and at a temperature of 13.6 to 14.9° C. In the beginning (RDS 2.6, 14° C., 52 bar), the flux was 0.36 l/min (30,06 l/m²/h); and in the end (RDS 17.2, 14.7° C., 58 bar), the flux was 0.005 l/min (0.45 l/m²/h).

Fractions 3.1 and 3.1m thus obtained were concentrated either by evaporation or RO treatment. The concentrated products were subjected to organoleptic analysis (see Example 2(F)).

1B(4) Additional Chromatographic Fractionation of a Permeate Obtained From the Ultrafiltration of Thick Juice With a Membrane Having a Cut-Off Size of 10 kD and Molasses:

The feed solutions were the same as in the chromatographic fractionation 1B(3) above.

A strongly acid cation exchange resin in Na⁺ form (Dowex monosphere 99K/350 with a bead size of 0.37 mm, manufactured by Dow chemicals, USA) was used as the separation resin. The separations were done as a batch type separation in a 200-liter column (with an inner diameter of 0.225 m) using the following separation conditions using water as the eluent:

| | |
|---|---|
| Resin bed height | 5.5 m |
| Feed size | 12 l (4.8 kg DS) for C-type permeate, |
| | 8 l (3.2 kg DS) for molasses |
| Feed RDS | 35 g/100 g |
| Temperature | 80° C. |
| Flow rate | 30 l/h |

Three fractions were collected from each separation. The first fraction (=the front-end fraction) from the chromatographic fractionation of thick juice permeate was numbered as fraction 3.1 and the first fraction from the chromatographic fractionation of molasses was numbered as fraction 3.1m as above. The fractions 3.1 and 3.1m were evaporated to a dry solids content of 35% using the same evaporation conditions as in Example 1B(1) above.

The evaporated fractions 3.1 and 3.1m and the corresponding feed solutions thereof were analyzed with regard to saccharides and some other organic components as well as cations and anions. The analysis results are set forth in the following Table 3:

TABLE 3
Contents of saccharides and some other organic
components as well as cations and anions in the feed
solutions and fractions 3.1 and 3.1 m obtained from the
chromatographic fractionation and evaporated to
an RDS of 35%

| | Feed 1 (thick | | | |
|---|---|---|---|---|
| | juice | | Feed 2 | |
| | permeate | Fraction 3.1 | (molasses) | Fraction 3.1 m |
| Content of | | | | |
| component, | | | | |
| % on DS | | | | |
| Raffinose | 0.6 | 1.2 | 2.9 | 2.3 |
| Sucrose | 94.7 | 0.4 | 62 | 1.8 |
| Glucose | 0.1 | 0.2 | 0.3 | <0.1 |
| Fructose | 0.1 | 0.4 | 0.4 | |
| Inositol | | | 0.2 | |
| Glycerol | 0.1 | 0.1 | 0.1 | |
| Betaine | 1 | 0.3 | 5.9 | 0.3 |
| Cations, | | | | |
| mg/kg solution | | | | |
| Na | 455 | 55300 | 4270 | 45900 |
| K | 3570 | 8830 | 23000 | 5910 |
| Ca | 82 | 9 | 414 | 21 |
| Mg | 5.6 | 6 | 21 | 13 |
| Fe | 2 | 43 | 20 | 43 |
| Anions, mg/kg | | | | |
| solution | | | | |
| Cl | 382 | 7450 | 2100 | 6440 |
| NO₃ | 276 | <700 | 1700 | 2960 |
| PO₄ | <200 | <700 | <200 | <700 |
| SO₄ | 1110 | 16200 | 4050 | 12100 |

The results of Table 3 show that fractions 3.1 and 3.1m do not contain essential amounts of saccharides, such as sucrose (saccharose), whereas they contain substantial amounts of salts (cations and anions). Furthermore, fractions 3.1 and 3.1m contain non-analyzed compounds not shown in Table 3, including those having a molar mass higher than that of saccharose.

Fractions 3.1 and 3.1m were evaporated to an RDS of about 35% using the same evaporation conditions as in Example 1B(1) above and subjected to organoleptic analysis.

### EXAMPLE (1C)

Ultrafiltration After the Chromatographic Fractionation:

The front-end fraction (fraction 3.1m) from the chromatographic fractionation of molasses (see Example 1B(4)) was evaporated to an RDS of about 20% and subjected to ultrafiltration using an ultrafiltration membrane of 10 kD. The permeate from the ultrafiltration was recovered and evaporated to an RDS of 35.5%. The evaporated permeate was called 3.1 mu and was subjected to organoleptic analysis (see Table 5c).

### EXAMPLE (1D)

Ultrafiltration of Fraction 3.1m From Molasses

A fraction 3.1m was evaporated to an RDS of about 20% and subjected to ultrafiltration using different ultrafiltration membranes. The membranes had a cut-off size of 50 kD, 10 kD and 2 kD, respectively. The permeates from the ultrafiltrations was recovered and evaporated to an RDS of 35%. The evaporated permeates (3.1 mu) were subjected to organoleptic analysis (see Example 2H).

### EXAMPLE 2

Results of sensory evaluation tests (organoleptic test results) of the fractions at various stages of development, carried out by a trained test panel.

2(A) Preliminary Taste Screening of Permeates/Concentrates Obtained From the Ultrafiltration/Nanofiltration:

A preliminary taste screening was carried out with permeates/concentrates obtained from the ultrafiltration/nanofiltration of thick juice and raw juice presented in Example 1A (see the permeates/concentrates shown in Table 1). The evaluation of the samples was carried out using a taste panel method, where panelists were tasting the samples blind. For tasting, the samples were either diluted to an RDS of 10.9% or they were tasted on top of refined sugar (for samples which had an RDS lower than 10.9%). The panelists were asked to taste and describe both the taste and aroma and score how acceptable the flavor was.

The panel was picking lots of different tastes and aromas from the thick juice and raw juice permeate/concentrate samples tested. As a general conclusion, the permeates obtained from ultrafiltration of thick juice with a membrane having a cut-off size of 2 kD and 10 kD gave the best taste results. These samples had a sweet taste and no unpleasant off-tastes like cheesy and yeasty character.

2(B) Flavor Evaluation of Beet Sugar (BS) Versus HFCS (High-Fructose Corn Syrup) With the Addition of Fractions of the Invention:

The purpose of the evaluation test was to look for various fractions derived from sugar beet to see if the addition of these fractions to HFCS (Raftisweet F55/71 manufactured by Orafti) will bring the flavor of HFCS closer to that of BS (crystalline saccharose made from sugar beet, Danisco A/S).

Evaluation Methods:

1. Tasting in Water

Various fractions of the product according to the invention (see Example 1B(1)) were added to water. The taste panel was then asked to present comments on the aroma and flavor character of the samples thus prepared.

The taste results showed that it was the front-end fraction (including predominantly macromolecules and salts) where the desired sweet malty brown taste was located. The 3.1 fraction had the best profile. The 6.1 fraction had similar taste, but somewhat weaker.

2. Comparison Test

Solutions of BS and HFCS were produced with an RDS of 10.9% and phosphoric acid content of 0.05%. Various fractions of the product of the invention to be tested (in different amounts) were added on top of the HFCS samples. The samples were allowed to stand for 48 hours before tasting tests. A trained taste panel was then asked to compare a sample containing only HFCS and samples containing HFCS and the fractions of the invention to be tested, against a reference sample based on standard beet sugar (BS). The panelists were asked to comment on the differences they found between the reference and the test sample and score how close the test samples match with the reference BS. A score of 10 means that it is a match and a score of 1 means that it is very far away.

A further test for those trials where the results were positive was carried out using a triangle test as the comparison.

3. Triangle Test

In this test the panel was given three samples, two of which were the same, and they were asked to pick the sample which was different.

The results from tests 2 and 3 confirmed that fraction 3.1 had the best profile.

2(C) Further Evaluation of Fraction 3.1

Fraction 3.1 was subjected to further evaluation. The results are set forth in Table 4. The evaluation was carried out using the comparison test method (2) described above. Fraction 3.1 had been pretreated by evaporation to an RDS of 13.2%, in accordance with Example 1B(1).

TABLE 4
Results of the comparison tasting of fraction 3.1

| Test sample | Average score |
|---|---|
| HFCS | 5.5 |
| (summary of all tests) | |
| HFCS + fraction 3.1 (120 ppm) | 7.4 |
| HFCS + fraction 3.1 (150 ppm), | 6.9 |
| (summary of all tests) | |
| HFCS + fraction 3.1 (200 ppm) | 5.8 |

In the test on fraction 3.1. at 120 ppm, comments on the main differences over BS were e.g. the following: very similar flavor but different mouthfeel, slightly less sweet, slightly less mouthfeel, slightly more acidic, possibly slightly sweeter also, slightly sweeter than BS, not as sweet, less sweet than BS, slightly brown note.

The results show that fraction 3.1 at an RDS of 13.2% and used at a level of 120 to 150 ppm (16 to 20 ppm as DS) on top of HFCS brought the taste of HFCS closer to BS. This was confirmed by the triangle test.

2(D) Comparison Between Flavored Soft Drinks (Either Full Sugar Drinks or Diet Drinks) and Flavored Soft Diet Drinks Containing the Fractions of the Invention:

Various fractions of the invention were added to a flavored soft drink (either a full sugar drink or a diet drink) using BS as reference. The fractions of the invention used in the tests were fractions 3.1 and 3.1m. The fractions 3.1 and 3.1m had been obtained in accordance with Example 1B(3). The fractions had been evaporated to an RDS of about 13.2% (after the chromatographic fractionation).

The taste panel was asked to taste the sample against the reference and score how near the sample is compared to the reference. A score of 10 means that it is a match and a score of 1 means that it is very far away. Panellists were also asked to present comments on the differences.

The full sugar drink was sweetened with sugar, whereas the diet drink was sweetened with aspartame and Acesulfame K.

The results are set forth in the following tables 5a to 5d.

TABLE 5a
Stage 1: Comparison between a diet drink and a full sugar drink

| Sample no. | Average score |
|---|---|
| Diet drink (summary of all tasting results) | 5.9 |

TABLE 5b
Stage 2: Effect of the addition of the fractions of the
invention at an RDS of 13.2% to a flavored soft diet drink.
Comparison between flavoured drink and full sugar

| Sample no | Average score |
|---|---|
| Fraction 3.1 (150 ppm RDS; 20 ppm as DS) | 5.5 |
| Fraction 3.1 (200 ppm RDS; 26 ppm as DS) | 6.1 |
| Fraction 3.1 (300 ppm RDS; 40 ppm as DS) | 6.1 |
| Fraction 3.1 (400 ppm RDS; 53 ppm as DS) | 5.5 |
| Fraction 3.1 (150 ppm RDS; 20 ppm as DS) | 5.3 |
| Fraction 3.1 m (30 ppm RDS; 4 ppm as DS) | 4.5 |
| Fraction 3.1 m (150 ppm RDs; 20 ppm as DS) | 5.3 |

The results of Table 5b show that the addition of 200 to 300 ppm of fraction 3.1 (25 to 40 ppm as DS) provided the best results and may be the desired level of addition to flavored soft drinks.

TABLE 5c
The effect of the addition of the ultrafiltered molasses
fraction 3.1 mu obtained in accordance with Example 1(C)
(at an RDS of 35.5%) to a flavored diet soft drink
compared to a full sugar drink.

| | Average |
|---|---|
| Sample no | score |
| Ultrafiltered fraction 3.1 mu (30 ppm RDS; 11 ppm as DS) | 4.5 |
| Ultrafiltered fraction 3.1 mu (50 ppm RDS; 18 ppm as DS) | 5 |
| Ultrafiltered fraction 3.1 mu (100 ppm RDS; 36 ppm as DS) | 7 |
| High fructose corn syrup | 5 |

The recipe of the flavored soft drink in the above was the following: Acesulfame K (0.12 kg), aspartame (0.12 kg), Caramel 15754 (1.05 liters), Caffeine (0.077 kg), Cola Flavoring U32915D (0.7 liters), phosphoric acid (85% m/m) (0.36 liters) and 100 liters water. The solution thus obtained was diluted in a ratio of 1 part solution plus 6 parts carbonated water. The ultrafiltered fraction 3.1 mu (at an RDS of 35.5%) was added on the top of the diluted solution.

2(E) Taste Evaluation of Subfractions of Fraction 3.1

For further evaluation, fraction 3.1 was collected as three separate fractions to produce subfractions 3.11, 3.12 and 3.13. The fractionation by chromatography has been described in Example 1B(2). Fractions 3.11, 3.12 and 3.13 had been evaporated to an RDS of about 35%.

The results of the tasting tests of the subfractions with HFCS are shown in Table 6.

TABLE 6
Results of the tasting tests of subfractions of fraction 3.1

| Sample | Score |
|---|---|
| HFCS with extract 3.11(100 ppm) at an RDS of 39% | 6.5 |
| (39 ppm as DS) | |
| HFCS with extract 3.12 (100 ppm) at an RDS of | 6.5 |
| 38.2% (38 ppm as DS) | |
| HFCS with extract 3.13 (100 ppm) at an RDS of 38% | 6.4 |
| (38 ppm as DS) | |

Furthermore, triangle tests were carried out comparing BS with HFCS and subfractions 3.11, 3.12 and 3.13 added at 100 ppm (on RDS) on top of HFCS. The RDS of the solutions was 10.9% and phosphoric acid was added at 0.05%.

Results of the triangle tests were the following:

With extract 3.11, 9 panelists out of 15 picked the correct answer, whereby there is a significant difference at 5% level. With extract 3.12, 10 panelists out of 15 picked the correct answer, whereby there is a significant difference at 1% level. With extract 3.13, 11 panelists out of 15 picked the correct answer, whereby there is a 0.1% significance level.

The results show that splitting fraction 3.1 into subfractions did not provide better results.

2(F) Tasting Tests on Fraction 3.1 (From Thick Juice) and Fraction 3.1m (From Molasses) Concentrated Either by RO or Evaporation

Tests were also carried out regarding the effect of the concentration method (reverse osmosis (RO) or evaporation) on the flavor of fractions 3.1 and 3.1m. The procedures for concentration by RO and concentration by evaporation have been described in Example 1B(3). The taste results for fraction 3.1 concentrated either by RO or evaporation to an RDS of about 17% are presented in Table 7.Table 7 also shows the results for fraction 3.1 concentrated both by RO and evaporation (to an RDS of about 35%). (after the RO treatment). The results for fraction 3.1m concentrated by evaporation are shown in Table 8.

The taste evaluation was carried out as a comparison test in HFCS using BS as a reference Fractions 3.1 and 3.1m were added in different amounts.

TABLE 7
Taste results for fraction 3.1 concentrated either by RO
or evaporation, obtained in accordance with Example 1B(3)

| | Average |
|---|---|
| Sample | score |
| Fraction 3.1 concentrated by RO (112 ppm) at an RDS of 17% | 6.5 |
| (19 ppm as DS) | |
| Fraction 3.1 concentrated by evaporation | 6.5 |
| (47 ppm) at an RDS of 36.8% (17 ppm as DS) | |
| Fraction 3.1 concentrated by RO then evaporation (47 ppm) at a | 6.2 |
| final RDS of 37.7% (18 ppm as DS) | |

The results of Table 7 show that there is no significant difference in the taste profile of fraction 3.1 concentrated either by RO or evaporation and in the taste profile of the same fraction 3.1 concentrated by RO and evaporation.

TABLE 8
Taste results for fraction 3.1 m concentrated by evaporation to an
RDS of 35%, obtained in accordance with Example 1B(3)

| | Average |
|---|---|
| Sample | score |
| Fraction 3.1 m, evaporated (10 ppm RDS; 3.5 as DS)) | 5.0 |
| Fraction 3.1 m, evaporated (20 ppm RDS; 7 ppm as DS) | 5.4 |
| Fraction 3.1 m, evaporated (30 ppm RDS; 10 ppm as DS) | 6.4 |
| Fraction 3.1 m, evaporated (40 ppm RDS; 14 ppm as DS) | 5.8 |
| Fraction 3.1 m, evaporated (50 ppm RDS; 18 ppm as DS)) | 5.2 |

The results of Table 8 show that a level of 30 ppm on RDS (10 ppm as DS) of fraction 3.1m was the optimum level for improving the taste.

2(G) Triangle Tests on Fraction 3.1 Concentrated Either by RO or Evaporation:

Triangle tests were carried out using HFCS and phosphoric acid as a base (RDS of 10.9%).

A comparison was made between fraction 3.1 concentrated by RO to an RDS of about 17% and the same fraction 3.1 concentrated by evaporation to an RDS of 37.7%. Five out of fifteen correctly picked the difference, so there was no significant difference between RO treatment and evaporation.

A further comparison was made between fraction 3.1 concentrated to an RDS of about 17% and then further concentrated by evaporation to an RDS of 36.8% and the same fraction 3.1 concentrated by evaporation to an RDS of 37.7%. Four out of fifteen correctly picked the difference, so there was no significant difference.

2(H) Tests on Fractions Ultrafiltered by 50 kD, 10 kD and 2 kD Membranes

Sensory evaluations were carried out for the ultrafiltered chromatographic fraction samples 3.1 mu obtained from molasses as in Example 1(D). A comparison was made between the three fractions first in water alone and then in an unflavored diet cola drink based on aspartame, caffeine, citric acid and phosphoric acid.

The 50 kD and 10 kD fractions had a stronger smell than the 2 kD fraction in water. In taste the 10 kD and 2 kD fractions were preferred over the 50 kD fraction and the preference for the 10 kD fraction increased on repeated tasting.

A further comparison was made between the fractions in the cola drink. In this test the panelists preferred the 10 kD and 50 kD fractions. The fractions were found to influence the on/offset of aspartame positively and gave the drink a more sugary impression.

### EXAMPLE 3

Beet molasses was subjected to a chromatographic separation. The feed solution was filtered and softened with ion exchanged with an ion exchange resin of type Imac C16 P before feeding. The separation was performed in a chromatographic separation column as a batch process. A chromatographic separation column with a diameter of 0.6 m was filled with a strongly acidic cation exchange resin (Finex CS 12 GC) manufactured by Finex Oy, Finland. The height of the resin bed was about 6 m. The cross-linkage degree of the resin was 5.5% DVB and the average particle size of the resin was 0.33 mm. The resin was regenerated into mainly Na+-form and a feeding device was placed at the top of the resin bed. The temperature of the column and feed solution and eluent water was approximately 85° C. The flow rate in the column was adjusted to 55 l/h.

The chromatographic separation was carried out as follows:

The dry substance content of the feed solution was determined and adjusted to 35 g dry substance in 100 g solution according to the refractive index (RI) of the solution. The pH of the feed solution was 7.0.

60 l of preheated feed solution was pumped to the top of the resin bed.

The feed solution was then eluted downwards in the column by feeding preheated ion-exchanged water to the top of the column. The pH and ion-form of the resin were balanced by several feeds before sampling.

The density and conductivity of the outcoming solution were measured continuously. The outcoming solution was collected as two fractions in the following order: first a fraction collected before the saccharose peak and containing salts, organic acids, colors and components other than monosaccharides, secondly a residual fraction containing most of the sucrose and betaine.

The fraction post treatment was done as follows.

The dry substance of the fraction was determined and evaporated to dry substance content of 20 g in 100 g of solution. The fraction was then subjected to ultra filtration in a laboratory scale ultra filtration unit, 2.5″ spiral wound, membrane area 1 m². The conditions in the ultrafiltration were: 70° C., inlet pressure 1 bar and pressure drop 0.5 bar over the membrane. The average flux during the ultrafiltration was 12 l/m²/h. The spiral wound membranes used were GR81PP (manufacturer DSS), 10 kD cut-off. As a last phase the permeate, as a desired fraction from UF, was evaporated to d.s 359/100 g.

The composition of the sample was analyzed with HPLC and a taste panel was used for sensory analysis.

The main cations of the sample were Na and K (about 100 g/kg of liquid of each) and the main anions were SO₄, Cl and NO₃ (in amounts between about 35 g/kg and about 5 g/kg) The sample contained about 5.5% raffinose, about 1,7% sucrose, and less than 0.1% of each of glucose, fructose, inositol and betaine. The sample contained 12.3% lactic acid, 6.1% L-2-pyrrolidone-5-carboxylic acid (PCA), 2.8% acetic acid, 1.9% formic acid and 1.0% citric acid, 0.23% aspartic acid, 0.2% glutamic acid and minor amounts of neutral amino acids. The percentages are calculated on the total dry substance in the fraction.

Sensory Analysis

A triangle method was used for the sensory analysis. The samples were tested in Diet Cola and compared to a reference sample of the fraction 3.1m obtained in example 1(C). Only 1 person out of 15 persons could detecta difference between the products. There is thus no statistically significant difference found between the samples.

### EXAMPLE 4

1000 kg beet molasses was carbonated and filtered with Seitz filter press using diatomaceous earth as filtering aid. The carbonated beet molasses was diluted to 35% (RDS) d.s. and subjected to ultra filtration. The ultra filtration was done in a pilot size ultra filtration unit, membrane area 30 m² at 70° C., inlet pressure 5 bar and pressure drop 3.5 bar over the membranes. The average flux during the ultra filtration was 18 l/m²/h. The spiral wound membranes used were GR81PP (manufacturer DSS), 10 kD cut-off.

The ultra filtration permeate was subjected to a chromatographic separation in a batch separation column. The separation was performed in a pilot scale chromatographic separation column as a batch process.

The column with a diameter of 1.0 m was filled with a strong acid cation exchange resin (Finex CS 11 GC) manufactured by Finex Oy, Finland. The height of the resin bed was approximately 6.0 m. The degree of cross-linkage was 5.5 w-% DVB and the average particle size of the resin was 0.35 mm. The resin was regenerated into sodium (Na⁺) form and a feeding device was placed at the top of the resin bed. The temperature of the column, feed solution and eluent water was 85° C. The flow rate in the column was adjusted to 550 l/h.

The pH of the feed solution was adjusted to pH 9.3 after which the solution was filtered.

The chromatographic separation was carried out as follows:

The dry substance of the feed solution was adjusted to 35 g dry substance in 100 g of solution according to the refractive index (RI) of the solution.

220 l of the preheated feed solution was pumped to the top of the resin bed.

The feed solution was eluted downwards in the column by feeding preheated ion-exchanged water to the top of the column. Several feeds were made for balancing the resin before sampling.

The density and conductivity of the outcoming solution were measured continuously. The outcoming solution was collected as two fractions in the following order: first a fraction collected before the saccharose peak and containing most of the salts, organic acids, colors and components other than monosaccharides, secondly a residual fraction containing most of the sucrose and betaine.

The dry substance yield from feed into first fraction was 28%.

The chemical analysis shows that the main cation of the sample was Na (about 55 g/kg of liquid) and the main anions were SO₄, Cl and NO₃ (in amounts between about 10 g/kg and about 2 g/kg) The sample contained about 5.5% raffinose, about 1,6% sucrose, and less than 0.1% of each of glucose, fructose and inositol and 0.1% betaine. The sample contained 4.2% lactic acid, 1.6% PCA, 1.0% acetic acid, and 0.2% citric acid and minor amounts of amino acids. The percentages are calculated on the total dry substance in the fraction.

Sensory Analysis

A triangle method was used for sensory analysis. The samples were tested in HIS (high intensity sweetener) soft drink base (Aspartame, Acesulphame K, caffeine and phosphoric acid) and compared to a reference sample of the fraction 3.1m obtained in example 1(C). The sample was not found to be significantly different from the reference sample. The tasted soft drink contained 100 ppm of product.

### EXAMPLE 5

Chromatographic Separation and Ultrafiltration of Molasses

The test equipment included three columns connected in series, feed pump, recycling pumps, an eluent water pump as well as inlet and product valves for the various process streams. The height of each column was 4 m and each column had a diameter of 0.111 m. The columns were packed with the same strong acid gel type cation exchange resin as used in example 3.

The feed material was beet molasses. The molasses was diluted to 60 weight % and carbonated with sodium carbonate (1.5% on DS basis, temperature 60° C., 3 h reaction time). The carbonated solution was then filtered with a Seitz pressure filter using Kenite 300 as a filtering aid. The pH of the feed solution was adjusted to about 7 and the feed concentration to 54 g/100 ml before the feeds. The composition is set forth in Table 9 below, whereby the percentages are given on a dry substance weight basis.

TABLE 9
Composition of feed

| | |
|---|---|
| Concentration, g/100 g | 54.7 |
| pH | 7.7 |
| Sucrose, % on DS | 60.0 |
| Betaine, % on DS | 6.5 |
| Others, % on DS | 33.5 |

The fractionation was performed by way of a 12-step SMB (simulated moving bed) sequence as set forth below. The feed and the eluent were used at a temperature of 85° C. and water was used as an eluent.

Step 1: 10.8 l of feed solution was pumped into the first column at a flow rate of 50 l/h and a sucrose fraction was collected from column 3.

Step 2: 6.7 l was circulated in the column set loop (separation profile circulation was continued), formed with all columns, at a flow rate of 50 l/h.

Step 3: 8.9 l of water was pumped into the third column at a flow rate of 65 l/h and the first part of the desired fraction was collected from column 2.

Step 4: 9.0 l was circulated in the column set loop (separation profile circulation was continued), formed with all columns, at a flow rate of 55 l/h.

Step 5: 12.3 l of water was pumped into the first column at a flow rate of 70 I/h and the second part of desired fraction was collected from column 3.

Step 6: 8.6 l was circulated in the column set loop (separation profile circulation was continued), formed with all columns, at a flow rate of 63 l/h.

Step 7: 11.5 l of water was pumped into column 2 at a flow rate of 70 l/h and the third part of desired fraction was collected from column 1.

Step 8: 7.7 l of water was pumped into the first column at a flow rate of 70 l/h and sucrose and betaine containing fraction was collected from column 3.

Step 9: 9.3 l of water was pumped into the first column at a flow rate of 68.7 l/h and the fourth part desired fraction was collected from the column 2. Simultaneously water was pumped into column 3 at a flow rate of 78 l/h and 10.1 l of betaine containing fraction was collected from column 3.

Step 10: 9.1 l of water was pumped into the first column at a flow rate of 70 l/h and betaine containing fraction was collected from column 3.

Step 11: 10.1 l of water was pumped into the first column at a flow rate of 70 l/h and the fifth part of the desired fraction was collected from column 3.

Step 12: 2.5 l was circulated in the column set loop (separation profile circulation was continued), formed with all columns, at a flow rate of 60 l/h.

With the described steps, the separation profile was circulated two times over the loop, during one cycle. After equilibration of the system, the following fractions were drawn from the system: a front fraction as a product fraction (containing salts, organic acids, colors and components other than monosaccharides), a fraction containing most of the sucrose and a fraction containing most of the betaine. The results including HPLC analyses for combined fractions are set forth in the Table 10 below.

TABLE 10

| Fractions | Sucrose | Betaine | Product |
|---|---|---|---|
| Volume, I | 18.5 | 21.2 | 52.1 |
| Concentration, g/100 ml | 20.0 | 3.4 | 3.0 |
| Sucrose, % on DS | 92.8 | 21.5 | 1.0 |
| Betaine, % on DS | 0.3 | 52.0 | 0 |
| Others, % on DS | 6.9 | 26.5 | 99.0 |

The dry substance yield from feed into desired fraction was 26%. The capacity was 6.6 kgDS/m³/h.

The fraction post treatment was done as follows:

The ultra filtration was done in a laboratory scale ultra filtration unit, 2,5″ spiral wound, membrane area 1 m². The conditions in ultrafiltration were: 70° C., inlet pressure 1 bar. The average flux during the ultrafiltration was 75 kg/m²/h. The spiral wound membranes used were GR81PP (manufacturer DSS), 10 kD cut-off. As a last phase the permeate, as a product fraction from UF, was evaporated to d.s 35 g/100 g.

The chemical analysis results show that the product after ultrafiltration contained about 14.4% K and about 4.2% Na. The product also contained about 5.0% raffinose, about 1,0% sucrose, and less than 0.1% of each of glucose, fructose, inositol and betaine. The product contained 10.1% lactic acid, 5.2 1% PCA, 2.6% acetic acid, 1.6% formic acid and 0.8% citric acid and only minor amounts of amino acids. The percentages are calculated on the total dry substance in the product fraction.

Sensory Analysis:

A paired comparison test method was used for sensory analysis. The sample was tested in a diet soft drink base without color and aroma. The sample was compared to the diet soft drink base with 100 ppm of a product fraction 3.1m obtained as described in example 1(C) as reference. The samples are compared regarding different descriptors. The descriptors used in this test were the aromas malt/molasses and caramel, the mouth feel water like, sweet duration, sweetness, sourness and bitterness. The panel contained of 20-25 assessors. The results lie in the average band of “score noise”. The sample of the present example was slightly more sour than the 3.1.m sample, but no statistically significant difference was found between the samples.

### EXAMPLE 6

Full Sugar Cola

The flavor improver of the present invention was tested as a Sweetener Module in a sweet cola drink and compared to control samples of standard cola drinks sweetened with beet sugar and High Fructose Corn Syrup (HFCS), respectively. The Sweetener Module was prepared from molasses as described in Example 1(C), i.e. by chromatographic fractionation and ultrafiltration through a 10 kD membrane. The Sweetener Module was used in the final drink at a dosage level of 14 ppm.

The recipes of the drinks are shown in the Table below

| | | High | High fructose |
|---|---|---|---|
| | | fructose | corn syrup |
| | | corn | cola with |
| | Beet sugar | syrup | Sweetener |
| | cola | cola | Module |
| | Dosage | Dosage | Dosage |
| Beet sugar (kg) | 11.3 | 0 | 0 |
| High Fructose Corn Syrup 55 (kg) | 0 | 9.3 | 9.3 |
| Caramel 15754 (ex Cerestar) (liter) | 0.15 | 0.15 | 0.15 |
| Caffeine (kg) | 0.011 | 0.011 | 0.011 |
| Cola Flavouring U32915 (liter) | 0.1 | 0.1 | 0.1 |
| Phosphoric acid (85% m/m) (liter) | 0.05 | 0.05 | 0.05 |
| Sweetener Module (liter) | 0 | 0 | 0.0014 |
| Carbonated water to make (liter) | 100 | 100 | 100 |

The ingredients were mixed together to make finished drinks containing a total of 10.9% (m/m) of soluble solids. The resulting cola drinks were then bottled. The drinks were subjected to a sensory tasting using a preference tasting method in which a control sample was tested against a sample containing the Sweetener Module.

Results

All three samples had a similar flavor profile except that the beet sugar control had a brown note not found in the HFCS sample without the Sweetener Module. The HFCS sample without the Sweetener Module was slightly less sweet, had slightly less mouthfeel and was slightly more acidic than either the beet sugar cola or the HFCS cola with the Sweetener Module.

It was concluded that the addition of the Sweetner Module to a HFCS sweetened cola drink brings the taste of the HFCS cola closer to the taste of a cola sweetened with beet sugar.

### EXAMPLE 7

Diet Cola

The flavor improver of the invention was tested as a Sweetener Module in a diet cola drink and compared to standard full sugar cola sweetened with beet sugar and to diet cola sweetnened with artificial high intensity sweeteners. The Sweetener Module was prepared from molasses as described in Example 3, i.e. by chromatographic fractionation and ultrafiltration through a 10 kD membrane. The Sweetner Module was used in the final drink at a level of 40 ppm.

The recipes of the drinks are shown in the Table below

| | | | Diet cola |
|---|---|---|---|
| | | | with |
| | Full sugar | | Sweetener |
| | cola | Diet cola | Module |
| Beet sugar (kg) | | 11.3 | 0 |
| Aspartame (kg) | 0 | 0.017 | 0.017 |
| Acesulpham K (kg) | 0 | 0.017 | 0.017 |
| Caramel 15754 (ex Cerestar) (liter) | 0.15 | 0.15 | 0.15 |
| Caffeine (kg) | 0.011 | 0.011 | 0.011 |
| Cola Flavouring U32915 (liter) | 0.1 | 0.1 | 0.1 |
| Phosphoric acid (85% m/m) (liter) | 0.05 | 0.05 | 0.05 |
| Sweetener Module (liter) | 0 | 0 | 0.004 |
| Carbonated water to make (liter) | 100 | 100 | 100 |

The ingredients were mixed together. The finished drink with sugar contained a total of 10.9% (m/m) of soluble solids. The resulting cola drinks were then bottled. The drinks were subjected to a sensory tasting using a preference tasting method in which a control sample was tested against a sample containing the Sweetener Module.

Results

Compared to the full sugar cola both diet drinks had less body and were less sweet, they also lacked depth of caramel taste. Based on the smell, the samples seemed quite close to each other, but based on the taste the artificial sweetener taste was particular evident in the standard diet cola sample without any Sweetener Module and less evident in the Sweetener Module sweetened sample. The sample of cola with the Sweetener Module was less bitter when compared to the cola without the Sweetener Module.

It was concluded that a diet drink containing the Sweetener Module of the present invention is closer in taste to a full beet sugar cola than is a diet cola without the Sweetener Module.

### EXAMPLE 8

White Grape Lemon Drink

The flavor improver of the present invention was tested as a Sweetener Module in a lemon drink at a dosage level of 60 ppm and compared to a control sample sweetened with only beet sugar. The Sweetener Module was prepared from molasses substantially as described in Example 1(C), i.e. by chromatographic fractionation and ultrafiltration through a 10 kD membrane.

The recipes of the drinks are shown in the Table below

| | Control | With Sweetener |
|---|---|---|
| | Dosage % | Module Dosage % |
| Sodium benzoate 25% in water | 0.04 | 0.04 |
| Sugar syrup 67° Brix | 12 | 12 |
| Lemon concentrate 46° Brix | 0.77 | 0.77 |
| White grape concentrate 67° Brix | 3.65 | 3.65 |
| Citric acid 50% in water | 0.05 | 0.05 |
| Lemon flavour PBD03919 | 0.1 | 0.1 |
| Sweetener Module | | 0.006 |
| Add slightly carbonated water to make | 100 | 100 |

A finishe drink contains:

| Flavour: | Natural |
|---|---|
| Juice: | 20% |

The ingredients were mixed together and bottled. The drinks were subjected to a sensory tasting using a preference tasting method in which a control sample was tested against a sample containing the Sweetener Module.

The sample with the Sweetener Module had more body, more fresh profile, more lemon notes, and it had a sweet and longer lasting flavor taste. The sample containing the Sweetener Module was preferred by the majority of panellists. This shows that the flavor improver of the present invention can be used to improve the taste and flavor of sugar beet sweetened products.

### EXAMPLE 9

Fruit Flavored Yoghurt

The flavor improver of the present invention was tested as a Sweetener Module in an artificially sweetened fruit flavored yoghurt and compared to a control sample sweetened only the artificial sweeteners. The Sweetener Module was prepared from molasses substantially as described in Example 3, i.e. by chromatographic fractionation and ultrafiltration through a 10 kD membrane.

The recipes of the fruit preparations are shown in the Table below

| | | With Sweetener |
|---|---|---|
| | Control | Module |
| Ingredients | Dosage % | Dosage % |
| GRINDSTED ® Pectin YF310 | 0.9 | 0.9 |
| Sugar I | 1.0 | 1.0 |
| Water 1 | 21.0 | 21.0 |
| Strawberry Fruit | 60.0 | 60.0 |
| Sugar II | 6.7 | 6.7 |
| Water II | 11 | 11 |
| K-sorbate, 20% w/v | 0.25 | 0.25 |
| Sodium citrate, 20% w/v | 0.05 | 0.05 |
| Ca-lactate, 5H₂O | 0.31 | 0.31 |
| Aspartame | 0.07 | 0.07 |
| Acesulfame K | 0.07 | 0.07 |
| Strawberry Flavouring PB3*35888 | 0.08 | 0.08 |
| Sweetener Module (dry weight) | | 0.006 |
| Yield after Evaporation | 100 | 100.0 |
| Final pH | | 3.8-4.0 |
| Filling temperature | | 30-40° C. |

The fruit flavored yoghurts were prepared as follows:

Procedure

1) Dry blend GRINDSTED® Pectin YF 310 and sugar I, and add the blend to 80° C. hot water I agitating vigorously.

2) Mix fruit, sugar II and water II and heat the blend to approx. 80° C.

3) Add the pectin solution, agitating continuously.

4) Evaporate to the desired content of soluble solids.

5) Add preservatives and adjust pH with citric acid.

6) Add flavouring.

7) Cool to filling temperature and blend with 80% yoghurt.

The yoghurts were subjected to a sensory tasting using a preference tasting method in which a control sample was tested against a sample containing the Sweetener Module. The Sweetener Module seemed to mask the artificial sweetener taste and improved the overall taste perception.

### EXAMPLE 10

Reduced Sugar Spread

A Sweetener Module which was prepared from molasses by chromatographic fractionation and ultrafiltration (10 kD) substantially as described in Example 1(C) was used as a flavor improver at a dosage level of 6 ppm (on DS) in a sweet spread. The spread had a reduced sugar level compared to standard spreads.

The formulation of the spread is shown in the Table below:

| | | With Sweetener |
|---|---|---|
| Formulation | Control | Module |
| Ingredients | Dosage % | Dosage % |
| GRINDSTED ® Pectin SF 560 | 0.8 | 0.8 |
| GRINDSTED ® LBG 147 | 0.1 | 0.1 |
| Sugar I | 3.6 | 3.6 |
| Water I | 18.0 | 18.0 |
| Fruit, 10% SS | 45.0 | 45.0 |
| Sugar II | 15.9 | 15.9 |
| Water II | 21.1 | 21.1 |
| K-sorbate, 20% w/v | 0.2 | 0.2 |
| Citric acid, H₂O, 50% w/v | As req. | As req. |
| Strawberry Flavouring | 0.2 | 0.2 |
| Sweetener Module (dry weight) | 0 | 0.006 |
| Total | 105.1 | 105.1 |
| Evaporation | 5.1 | 5.1 |
| Yield | 100 | 100.0 |
| Final soluble solids | | 25% |
| Final pH | | 3.2-3.3 |
| Filling temperature | | 40-50° C. |

The spreads were prepared according to the following procedure:

1) Dry blend GRINDSTED® Pectin SF 560, GRINDSTED® LBG 147 and sugar I, and add the blend to 80° C. hot water I agitating vigorously.

2) Mix fruit, sugar II and water II and heat the blend to approx. 80° C.

3) Add the pectin solution, agitating continuously.

4) Evaporate to the desired content of soluble solids.

5) Add preservatives and adjust pH with citric acid.

6) Add flavoring.

7) Cool to filling temperature and fill.

The fruit spreads were subjected to a sensory tasting using a preference tasting method in which a control sample was tested against a sample containing the Sweetener Module.

The Sweetener Module increased the sweetness of the fruit spread. The Sweetener Module also changed the flavor profile by reducing the acidity, and it changed the taste form a green unripe strawberry to a fresh fruity ripe strawberry.

### EXAMPLE 11

Lemon Flavored Alcoholic Beverage

A Sweetener Module produced as in Example 10 was used as a flavor improver in a fruit flavored alcoholic drink sweetened with High Fructose Corn Syrup (HFCS). The Sweetener Module flavored drink was compared to a drink sweetened with only HFCS.

The recipes of the drinks are shown in the Table below

| | | With Sweetener |
|---|---|---|
| | Control | Module |
| | Dosage % | Dosage % |
| Sodium benzoate | 0.014 | 0.014 |
| High Fructose Corn Syrup 55 | 8.3 | 8.3 |
| Citric acid monohydrate | 0.45 | 0.45 |
| Lemon flavouring N118202 | 0.2 | 0.2 |
| Sweetener Module (dry weight) | 0 | 0.0032 |
| Malt base R80343 | 35.7 | 35.7 |
| Vodka | 1.25 | 1.25 |
| Add carbonated water to make | 100 | 100 |

The ingredients were mixed together to make finished drinks having an alcohol content of 5.5%. The resulting drinks were then bottled. The drinks were subjected to a sensory tasting using a preference tasting method in which a control sample was tested against a sample containing the Sweetener Module.

In the tasting 83% of the panelist preferred the sample containing the Sugar Module. They commented that the drink containing the Sweetener Module had a better impact and a fruitier juicier lemon character.

It is evident that the flavor delivery of a fruit flavored alcoholic long drink can be improved by the Sweetener Module of the present invention making the drink more acceptable to consumers.

### EXAMPLE 12

Ice Cream

The flavor improver of the present invention was tested as a Sweetener Module in various ice cream recipes both such with normal sugar sweetners and such with artificial sweeteners. The Sweetener Module was prepared from molasses by chromatographic fractionation and ultrafiltration through a 10 kD membrane.

12 a) Standard non-fat ice creams were prepared with normal sugar (Glucose & Sucrose) and supplemented with Cremarome (Danisco A/S) on one hand and with the Sweetener Module on the other hand.

The ice cream with the Sweetener Module showed an increased sweetness compared to the one with Cremarome.

12 b) Tooth-friendly no-fat ice creams were prepared with no sugar and using Aspartame as a sweetener. The control sample was sweetened only with Aspartame while the test sample additionally included the Sweetener Module.

The sweet taste of the ice cream was improved with the Sweetener Module. Moreover, the sugar taste and the vanilla taste were improved by the Sweetener Module.

The above examples serve to illustrate the invention. It will be obvious to a person skilled in the art that, as the technology advances, the inventive concept can be implemented in various ways. The invention and its embodiments are not limited to the examples described above but may vary within the scope of the claims.

1. An edible flavor improver comprising an essentially non-volatile mixture containing non-sucrose components of sugar beet extract, said mixture being effective in enhancing the organoleptic characteristic(s) of ingestible products and being obtainable by fractionation of said sugar beet extract.

2. The flavor improver of claim 1, wherein said non-sucrose components in combination are effective in enhancing said organoleptic characteristics.

3. The flavor improver of claim 1 or 2, wherein said fractionation is selected from crystallization, evaporation, chromatographic separation, membrane filtration and combinations thereof.

4. The flavor improver of claim 3, wherein said sugar beet extract has been desugarized and evaporated prior to said fractionation.

5. The flavor improver of claim 4, wherein said sugar beet extract comprises molasses.

6. The flavor improver of claim 3 or 5, wherein said fractionation comprises ultrafiltration and said mixture has permeated a filter having a molar mass cut-off of 50 kD, preferably 10 kD.

7. The flavor improver according to claim 3 or 5, wherein said fractionation comprises chromatographic fractionation.

8. The flavor improver of claim 7, wherein said chromatographic fractionation is a batch fractionation or a continuous fractionation.

9. The flavor improver of claim 7, wherein said fraction comprises a front end fraction of a batch chromatographic fractionation of said extract.

10. The flavor improver of claim 8, wherein said chromatographic fraction comprises an essentially non-betaine fraction of said extract.

11. The flavor improver of claim 1, wherein said mixture contains a multitude of compounds deriving from the beet sugar process and wherein the main components comprise salts, organic acids and compounds other than monosaccharides and betaine.

12. The flavor improver of claim 11, wherein the main cations of said salts are selected from sodium, potassium and calcium and the main anions of said salts are selected from sulphate, chloride, nitrate, phosphate and oxalate.

13. The flavor improver of claim 11, wherein said mixture contains organic acids selected from lactic acid, pyrrolidone carboxylic acid (PCA), acetic acid, citric acid and mixtures thereof.

14. The flavor improver according to claim 13, wherein said mixture contains less than a total of 45%, preferably 35 to 10% of said organic acids calculated on the dry substance.

15. The flavor improver according to claim 11, wherein said mixture contains raffinose and/or sucrose in an amount of less than 60%, preferably less than 20%, most preferably less than 10% calculated on the dry substance, respectively.

16. The flavor improver according to claim 11, wherein said mixture contains less than 1%, preferably less than 0.5% of each of glucose and fructose calculated on the dry substance.

17. The flavor improver according to claim 11, wherein said mixture contains less than 10%, preferably less than 5% of amino acids calculated on the dry substance.

18. The flavor improver of claim 1, wherein said mixture is provided in admixture with a nutritionally and/or pharmaceutically acceptable vehicle or carrier.

19. The flavor improver of claim 1 wherein said mixture is effective in enhancing the organoleptic characteristic(s) by providing or enhancing sugar like taste, improving mouth feel, changing fruit flavor profile, reducing or masking bitterness, reducing or masking artificial sweetener taste, improving aftertaste, decreasing acidity, reducing sharpness, prolonging sweet taste or combinations thereof.

20. The flavor improver of claim 1, wherein said ingestible product comprises nutritionally and/or pharmaceutically acceptable products selected from beverages, dairy products, fruit and berry products, savory, soya based products, confectionery, bakery products, desserts, and sweetened pharmaceutical products.

21. The flavor improver of claim 1 wherein said ingestible product is a sweetened product which is sweetened with sucrose or a non-sucrose sweetener selected from high fructose corn syrup, polyols and artificial sweeteners like saccharin, aspartame, potassium acesulfame, sucralose, neotame, alitame, cyclamate as well as combinations thereof.

22. The flavor improver of claim 1, wherein said sugar beet extract is molasses and said fractionation comprises fractionation by chromatographic separation, ultra filtration or a combination thereof.

23. The flavor improver of claim 1, wherein said fractionation process comprises, in any desired sequence, at least one membrane filtration and at least one chromatographic fractionation of a liquid withdrawn from a beet sugar manufacturing process, and recovering a product comprising a compound or a mixture of compounds having a molar mass lower than about 50 kD, said compounds consisting predominantly of salts and molecules having a molar mass higher or lower than that of saccharose.

24. The flavor improver of claim 1, which is prepared by a process comprising membrane filtration of a liquid withdrawn from a beet sugar manufacturing process to obtain a retentate and a permeate; recovering said permeate; chromatographic fractionation of said permeate to obtain a front end fraction and at least one other fraction; and recovering said front end fraction.

25. The flavor improver of claim 1, which is prepared by a process comprising ultrafiltration of thick juice withdrawn from a beet sugar manufacturing process using an ultrafiltration membrane having a cut-off size of up to about 10 kD to obtain a permeate and a retentate; recovering said permeate; chromatographic fractionation of said permeate to obtain a front-end fraction and at least one other fraction; and recovering said front-end fraction.

26. The flavor improver of claim 1, which is prepared by a process comprising chromatographic fractionation of molasses withdrawn from a beet sugar manufacturing process to obtain a front-end fraction and at least one other fraction; recovering said front-end fraction; and optional membrane filtration of said front-end fraction.

27. The flavor improver of claim 1 which is prepared by a process comprising chromatographic fractionation of molasses withdrawn from a beet sugar manufacturing process to obtain a front-end fraction and at least one other fraction; recovering said front-end fraction; ultrafiltration of said front-end fraction using an ultrafiltration membrane having a cut-off size of up to 10 kD to obtain a permeate and a retentate; and recovering said ultrafiltration permeate; and optional concentration of said ultrafiltration permeate.

28. A process for producing an edible flavor improver comprising the steps of providing a sugar beet extract, fractionating said extract, and recovering a fraction comprising an essentially non-volatile mixture containing non-sucrose components of said sugar beet extract, which mixture is effective in enhancing the organoleptic characteristic(s) of ingestible products.

29. The process according to claim 28, wherein said fractionation is selected from crystallization, evaporation, chromatographic separation, membrane filtration and combinations thereof.

30. The process according to claim 29, wherein said process includes crystallization and/or chromatographic separation to remove sucrose and evaporation to remove volatile components.

31. The process according to claim 29, wherein said sugar beet extract comprises molasses.

32. The process according to claim 29, wherein said fractionation comprises ultrafiltration with a membrane having a cut-off size of up to 50 kD, preferably up to 10 kD and said recovery comprises recovering the permeate of said filtration.

33. The process according to claim 32, wherein said fractionation comprises a chromatographic separation and said recovery comprises recovery of a desugarized and/or debetainized fraction

34. The process according to claim 33, wherein said chromatographic separation is carried out using an acid cation exchange resin, preferably a strongly acid cation exchange resin in sodium or potassium form.

35. The process according to claim 34, wherein said extract comprises molasses and said fractionation is provided by a process selected from chromatographic separation, membrane filtration and combinations thereof.

36. The process according to claim 28, wherein said fractionation comprises chromatographic separation to cause desugarization and debetainization of said extract and ultra filtration to cause removal of compounds having a molar mass higher than 50 kD.

37. The process according to claim 28, wherein said sugar beet extract and/or said fraction is additionally treated by ion exchange and/or carbonation.

38. A process for preparing a flavor improver product based on a sugar beet extract, comprising at least one membrane filtration and/or at least one chromatographic fractionation, in any desired sequence, of a liquid withdrawn from a beet sugar manufacturing process; and recovering a product comprising a compound or a mixture of compounds having a molar mass lower than about 50 kD, said compounds consisting predominantly of salts and molecules having a molar mass higher or lower than that of saccharose.

39. Use of a product according to any one of claims 1 to 27 as a flavor improver in a nutritionally or pharmaceutically acceptable ingestible product in an amount which is effective in enhancing the organoleptic characteristics of said product.

40. The use according to claim 39, wherein said product is a sweetened product selected from a sucrose sweetened product, a non-sucrose sweetened product and a reduced sucrose sweetened product.

41. The use according to claim 39 or 40, wherein said product is sweetened with a non-sucrose sweetener and said flavor improver enhances the organoleptic properties of said product so as to make it more like a sucrose sweetened product.

42. The use according to claim 41, wherein said non-sucrose sweetener is selected from the group consisting of high fructose corn syrup, polyols and artifical sweeteners like saccharin, aspartame, potassium acesulfame, sucralose, neotame, alitame, cyclamate, and combinations thereof.

43. The use according to claim 39, wherein said product is selected from beverages, dairy products, fruit and berry products, savoury, soya based products, confectionery, bakery products, desserts, and sweetened pharmaceutical products.

44. The use according to claim 42, wherein said flavor improver is used in said ingestible product in an amount between 1 and 2000 ppm, preferably 5 to 500 ppm, most preferably 10 to 200 ppm (as dry substance of the flavor improver).

45. The use according to claim 43, wherein said product is a beverage selected from soft drinks, sports drinks, diet drinks, juices, juice drinks, tea, coffee, beer, cider and flavoured alcoholic beverages.

46. The use according to claim 39, wherein said organoleptic characteristics are selected from sugar-like taste, ripe fruit flavor, reduced acidity, reduced or masked bitterness, reduced or masked artificial sweetener taste, reduced sharpness, increased sweetness, prolonged sweet taste, improved texture, improved mouth feel, improved after taste, and combinations thereof.

47. The use according to claim 45, wherein said beverage is a diet soft drink sweetened with a non-sucrose sweetener and said flavor improver is used to bring the taste of said diet soft drink closer to the taste of a corresponding sucrose sweetened soft drink.

48. The use according to claim 47, wherein said soft drink is a cola drink.

49. The use according to claim 43, wherein said product is a fruit flavored product and said flavor improver is used to improve the flavor profile of the product to a more ripe fruit flavor than without said flavor improver.

50. The use according to claim 48, wherein said product is selected from a jam, a marmalade, a fruit flavoured yogurt, a fruit drink, an ice cream, a fruit confectionery and a fruit dessert.

51. The use according to claim 45, wherein said beverage is beer or a flavored alcoholic drink and said flavor improver is used to reduce the bitterness, acidity and/or alcohol burn taste.

52. A process for modifying the organoleptic characteristics of ingestible products, comprising adding to said product an effective amount of a flavor improver according to any one of claims 1 to 27.

53. A sweetening composition comprising a sweetener and an amount of the flavor improver according to any one of claims 1 to 27 which is effective in enhancing the organoleptic characteristic(s) of said sweetener in an ingestible product.

54. An ingestible product which is sweetened with a sucrose or non-sucrose sweetener and which includes an effective amount of the flavor improver according to any one of claims 1 to 27.
